(19) United States
(12) Patent Application Publication
(10) Pub. No.: US 2026/0022277 A1
(43) Pub. Date: Jan. 22, 2026

(54) CURABLE COMPOSITIONS

(71) Applicant: Arkema France, Colombes (FR)

(72) Inventors: Donald HERR, Exton, PA (US); Jon SCHOLTE, Exton, PA (US); Christopher MACNEILL, Exton, PA (US); Renee KONTOS, King of Prussia, PA (US); Linda FRANCESCHINI, Exton (PA); Philippe CICERON, Senlis (FR); Kevin DEMOULIN, Verneuil En Halatte (FR); Pierre MELEC, Verneuil En Halatte (FR); Christophe VERGE, Verneuil En Halatte (FR)

(21) Appl. No.: 18/995,973

(22) PCT Filed: Jul. 20, 2023
(86) PCT No.: PCT/EP2023/070237

§ 371 Date: Jan. 17, 2025

(30) Foreign Application Priority Data
Jul. 20, 2022 (EP) 22.306079.9

(51) Int. Cl. C09J 7/38

(52) U.S. Cl. CPC C09J 7/385; C09J 2301/302; C09J 2301/414; C09J 2301/416

(57) ABSTRACT

The present invention relates to a curable composition comprising an oligomer and a low viscosity reactive diluent. The oligomer comprises polymerized high T_{g} monomer units, polymerized low T_{g} monomer units, polymerized chromophore monomer units, and optionally at least one polymerized additional monomer unit. The invention also relates to use of the curable composition as a pressure sensitive adhesive curable composition and methods of coating a substrate.

### TECHNICAL FIELD

The present invention relates to a curable composition comprising an oligomer and a low viscosity reactive diluent. The oligomer comprises polymerized high T_{g} monomer units, polymerized low T_{g} monomer units, polymerized chromophore monomer units, and optionally at least one polymerized additional monomer unit. The invention also relates to use of the curable composition as a pressure sensitive adhesive curable composition and methods of coating a substrate.

### BACKGROUND

Pressure sensitive adhesive (PSA) systems are generally based on acrylic, styrenic block copolymers or urethane chemistry, which have certain drawbacks during processing and film-forming. For example, solvent-based PSA systems contain volatile organic compounds, which may be difficult to evaporate. Such difficulty limits their application due to environmental and performance requirements.

Radiation curable PSA systems offer many advantages over known PSA systems, such as fast curing time, good processability, and environmental safety. However, it may be challenging to develop curable PSA systems that realize desired characteristics, such as high peel strength. Thus, there is a need for radiation curable PSA systems having high peel strength.

Embodiments of the curable compositions disclosed herein overcome drawbacks associated with known PSA systems.

### SUMMARY

A first aspect of the invention is a curable composition comprising an oligomer and a low viscosity reactive diluent having a viscosity equal to or less than 3000 cP at 25° C. The oligomer comprises, based on the total weight of the oligomer: from 1% to 80% by weight polymerized high T_{g} monomer units, the high T_{g} monomer units being chosen from (meth)acrylate monomers having a glass transition temperature (T_{g}) greater than 25° C.; from 10% to 98.9% by weight polymerized low T_{g} monomer units, the low T_{g} monomer units being chosen from monovalent (meth)acrylate monomers having a T_{g} equal to or less than 25° C.; from 0.1% to 40% by weight polymerized chromophore monomer units, the chromophore monomer units being chosen from (meth)acrylate monomers having a pendent Norrish Type II chromophore; and from 0% to 20% by weight at least one polymerized additional monomer units. The oligomer has a weight average molecular weight of at least 10,000 grams per mole (g/mol). The oligomer has a T_{g} equal to or less than −10° C. The curable composition has a viscosity of equal to or less than 50,000 cP at 60° C.

The invention also relates to a method of preparing the curable composition of the invention, wherein the method comprises the following steps:
preparing an oligomer as defined herein dissolved in a non-reactive solvent;
adding a low viscosity reactive diluent to obtain a diluted curable composition;
removing at least part of the non-reactive solvent from the diluted curable composition to obtain the curable composition.

The invention also relates to a method of curing the curable composition of the invention or prepared by the method of the invention, wherein the method comprises curing the curable composition by irradiating the curable composition with a light source having a wavelength and/or an intensity that is able to activate the polymerized chromophore monomer units of the oligomer and cause crosslinking of said oligomer and/or said reactive diluent.

### DESCRIPTION OF DRAWINGS

FIG. 1 is a graph of gel content of cured comparative examples and examples according to one or more embodiments described herein;

FIG. 2 is a graph of gel content of cured comparative examples and examples according to one or more embodiments described herein;

FIG. 3 is a graph of gel content of cured comparative examples and examples according to one or more embodiments described herein;

FIG. 4 is a graph of cure speed and heat flow area under curve of comparative example and examples according to one or more embodiments described herein;

FIG. 5 is a graph of cure speed and heat flow area under curve of comparative example and examples according to one or more embodiments described herein;

FIG. 6 is a graph of cure speed of examples according to one or more embodiments described herein;

FIG. 7 is a graph of average load relative to peel strength of examples according to one or more embodiments described herein;

FIG. 8 is a graph of average load relative to peel strength of comparative examples and examples according to one or more embodiments described herein; and

FIG. 9 is a graph of average load relative to peel strength of comparative examples and examples according to one or more embodiments described herein.

### DETAILED DESCRIPTION

### Definitions

As used herein, the term “comprises a” may mean “comprises one or more”.

Unless otherwise mentioned, the weight percentages in a compound or a composition are expressed relative to the weight of the compound, respectively of the composition.

The term “substitution” herein means that at least one hydrogen atom (—H) bonded to a carbon atom or heteroatom of a corresponding unsubstituted compound or functional group is replaced by a substituent (e.g. R^{S}). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent. Unless otherwise defined or limited in a specific context, a substituent group generally, or a substituent group referred to as R^{S}, may be any chemical moiety, typically, but not necessarily limited to, a chemical moiety having from 1 to 50, or from 1 to 40, or from 1 to 30, or from 1 to 20, or from 1 to 10 total atoms. Examples of substituent groups R^{S} include, but are not limited to, a hydrocarbyl, a heterohydrocarbyl, an aryl, a heteroaryl, an alkyl, a cycloalkyl, a heteroatom, a carbonyl, a hydroxy, an ester, an amine, an amide, or a halide according to their respective definitions herein or their commonly understood meaning, any of which substituents themselves may be substituted or unsubstituted. In some embodiments, substituents R^{S} may be chosen from a (C₁-C₃₀)hydrocarbyl, a (C₁-C₃₀)heterohydrocarbyl, a (C₆-C₃₀)aryl, or a (C₆-C₃₀)heteroaryl.

The term “hydrocarbyl” means a monovalent hydrocarbon, in which each hydrocarbon is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S}, or unsubstituted. In this disclosure, hydrocarbyl may be an unsubstituted or substituted alkyl, an unsubstituted or substituted cycloalkyl, or an unsubstituted or substituted aryl. A hydrocarbyl may not comprise any heteroatom selected from O, N or S. A (C₁-C₃₀)hydrocarbyl is a hydrocarbyl having from 1 to 30 carbon atoms.

The term “heterohydrocarbyl” means a hydrocarbyl bearing one or more heteroatoms independently selected from O, N or S. A (C₁-C₃₀)heterohydrocarbyl is a heterohydrocarbyl having from 1 to 30 carbon atoms.

The term “aryl” means an optionally substituted polyunsaturated aromatic group. The aryl may contain a single ring (i.e. phenyl) or more than one ring wherein at least one ring is aromatic. When the aryl comprises more than one more ring, the rings may be fused, linked via a covalent bond (for example biphenyl). The aromatic ring may optionally comprise one to two additional fused rings (i.e. cycloalkyl, heterocycloalkyl or heteroaryl). Examples include phenyl, naphtyl, biphenyl, phenanthrenyl and naphthacenyl.

The term “alkyl” means a monovalent saturated acyclic hydrocarbon group of —CₙH₂ₙ₊₁ wherein n is 1 to 20. An alkyl may be linear or branched. Examples of alkyl groups include methyl, ethyl, propyl, isopropyl, butyl, isobutyl, tert-butyl, pentyl, hexyl, 2-methylbutyl, 2,2-dimethylpropyl, n-hexyl, 2-methylpentyl, 2,2-dimethylbutyl, n-heptyl, 2-ethylhexyl, and the like.

The term “cycloalkyl” means a monovalent saturated alicyclic hydrocarbon group comprising a cycle. Examples of cycloalkyl groups include cyclopentyl, cyclohexyl and isobornyl.

The term “heterocycloalkyl” means a cycloalkyl having at least one ring atom that is a heteroatom selected from O, N or S.

The term “halogen” means an atom selected from Cl, Br, F and I.

The term “alkoxy” means a group of formula —O-alkyl, wherein the alkyl is as defined above.

The term “aryloxy” means a group of formula —O-aryl, wherein the aryl is as defined above.

The term “thioalkyl” means a group of formula —S-alkyl, wherein the alkyl is as defined above.

The term “thioaryl” means a group of formula —S-aryl, wherein the aryl is as defined above.

The term “alkenyl” means a monovalent acyclic hydrocarbon group comprising at least one C═C double bond. An alkenyl may be linear or branched.

The term “alkynyl” means a monovalent acyclic hydrocarbon group comprising at least one C≡C triple bond. An alkynyl may be linear or branched.

The term “aralkyl” means an aryl substituted by an alkyl group. An example of an aralkyl group is tolyl.

The term “alkaryl” means an alkyl substituted by an aryl group. An example of an alkaryl group is benzyl (—CH₂-Phenyl).

The term “heteroaryl” means an aryl having at least one ring atom that is a heteroatom.

The term “alkylamino” means an alkyl substituted by at least one amino group.

The term “alkylthiol” means an alkyl substituted by at least one thiol group

The term “hydroxyalkyl” means an alkyl substituted by at least one hydroxy group.

The term “haloalkyl” means an alkyl substituted by at least one halogen.

The term “alkylene” means a linker derived from an alkane of formula CₘH₂ₘ₊₂ by removing one hydrogen atom at each point of attachment of the linker. An alkylene may be divalent, trivalent, tetravalent or have even higher valencies.

The term “alkoxylated” means a compound, group or linker containing one or more oxyalkylene moieties, in particular one or more oxyalkylene selected from oxyethylene (—O—CH₂—CH₂—), oxypropylene (—O—CH₂—CH(CH₃)— or —O—CH(CH₃)—CH₂—), oxybutylene (—O—CH₂—CH₂—CH₂—CH₂—) and mixtures thereof. For example, an alkoxylated compound, group or linker may contain from 1 to 30 oxyalkylene moieties.

The term “(meth)acrylate” means acrylate or methacrylate. The term “acrylate” means an acryloyloxy group (—O—C(═O)—CH═CH₂). The term “methacrylate” means a methacryloyloxy group (—O—C(═O)—C(CH₃)═CH₂).

The term (meth)acrylate monomer means a monomer bearing a (meth)acrylate group.

As used herein, the term “monomers” have a number average molecular weight of less than 1,000 g/mol, preferably 100 to 950 g/mol.

As used herein, the term “oligomers” have a number average molecular weight from equal to or more than 1,000 g/mol, preferably 1,050 to 60,000 g/mol, more preferably 10,000 to 50,000 g/mol.

As used herein, “number average molecular weight (‘Mₙ’)” or “weight average molecular weight (‘M_{w}’)” are determined using a size exclusion chromatography (SEC) using poly(methyl methacrylate) reference standards and tetrahydrofuran as the solvent, unless expressly noted otherwise.

The term “glass transition temperature” or “T_{g}” refers to the temperature at which a material changes from a glassy state to a rubbery state. In this context, the term “glassy” means that the material is hard and brittle while the term “rubbery” means that the material is elastic and flexible. For polymeric materials, the T_{g} is the critical temperature that separates their glassy and rubbery behaviors. If a polymeric material is at a temperature below its T_{g}, large-scale molecular motion is severely restricted because the material is essentially frozen. On the other hand, if the polymeric material is at a temperature above its T_{g}, molecular motion on the scale of its repeat unit takes place, allowing it to be soft or rubbery.

All references herein to a T_{g} of a monomer refer to the T_{g} of a homopolymer formed from that monomer. T_{g} values of common monomers are well-known from literature. If not reported in the literature, the glass transition temperature values may be determined in accordance with ASTM E1356-08, “Standard Test Method for Assignment of the Glass Transition Temperatures by Differential Scanning Calorimetry” as the inflection temperature (Ti). The glass transition temperatures of the oligomers described herein and mentioned in the examples below are calculated using the Fox Equation based on the mass fractions and T_{g} values of each individual monomer of oligomer or the polymeric material that includes more than one discrete type of monomer. The T_{g} of the curable composition when cured is determined by the above-described ASTM E1356-08 DSC method or, if not possible owing to a lack of a detectable inflection point, by shear rheology.

The terms “mass fraction” and “weight fraction” are used herein interchangeably and are to be regarded as equivalent to each other with respect to embodiments or examples herein.

The “Fox Equation” refers to equation (1):

$$1 / {T}_{g , mix} = \sum i {ω}_{i} / {T}_{g , i} \qquad equation ( 1 )$$

where T_{g, mix} is the glass transition temperature of a mixture of i chemically discrete components, such as two or more discrete monomers of an oligomer or polymer, T_{g,i} is the glass transition temperature of the i-th component, and ωᵢ is the mass fraction of the i-th component, based on the total mass of the oligomer or polymer. Hereinafter, the value T_{g, mix} with respect to multiple discrete monomers in an oligomer or polymer is referred to as the “Fox Equation average T_{g}” of the multiple discrete monomers.

For two components, A and B, the Fox Equation reduces to equation (2):

$$1 / {T}_{g , mix} \approx {ω}_{A} / {T}_{g , A} + {ω}_{B} / {T}_{g , B} \qquad equation ( 2 )$$

The term “high-T_{g} monomer unit” refers to a monomer that, when homopolymerized, produces a homopolymer having a T_{g} of equal to or greater than 25° C. In embodiments of the oligomer, for which only one kind of high-T_{g} monomer unit is present in the oligomer, the T_{g} of the high-T_{g} monomer units is the T_{g} of a homopolymer of the one kind of high-T_{g} monomer unit. In embodiments of the oligomer, for which two or more types of distinct high-T_{g} monomer units are present in the oligomer, the T_{g} of the high-T_{g} monomer units of the oligomer collectively refers to the Fox Equation average T_{g} of the combination of the high-T_{g} monomer units, in which for equation (1) the individual mass fractions ωᵢ are mass fractions of each individual high-T_{g} monomer unit in the oligomer, based on the total mass of all the high-T_{g} monomer units present in the oligomer (that is, the monomer units having a T_{g} of equal to or greater than 25° C.), not on the total mass of the oligomer as a whole.

The term “Fox Equation average” may be used herein even with respect to a single monomer that is not part of a mixture of two or more monomers. It should be readily understood that a Fox Equation average T_{g} with respect to a single monomer is equivalent to the T_{g} of the single monomer itself, as defined herein, as the term mass fraction term co in such a situation would equal one.

The term “low-T_{g} monomer unit” refers to a monomer that, when homopolymerized, produces a homopolymer having a T_{g} of less than 25° C. In embodiments of the oligomer, for which only one kind of low-T_{g} monomer unit is present in the oligomer, the T_{g} of the low-T_{g} monomer units is the T_{g} of a homopolymer of the one kind of low-T_{g} monomer unit. In embodiments of the oligomer, for which two or more types of distinct low-T_{g} monomer units are present in the oligomer, the T_{g} of the low-T_{g} monomer units of the oligomer collectively refers to the Fox Equation average T_{g} of the combination of the low-T_{g} monomer units, in which for equation (1) the individual mass fractions ωᵢ are mass fractions of each individual low-T_{g} monomer unit in the oligomer, based on the total mass of all the low-T_{g} monomer units present in the oligomer (that is, the monomer units having a T_{g} of less than 25° C.), not on the total mass of the oligomer as a whole.

The term “photoinitiator” may be considered any type of substance that, upon exposure to radiation (e.g., actinic radiation), forms species that initiate the reaction and curing of polymerizing organic substances present in a curable composition.

The term “chromophore” refers herein to a Norrish Type II light absorbing molecule that enters an exited state upon absorbing light. From this excited state, the molecule can interact or react with other molecules to produce reactive radical species.

When used to describe certain carbon atom-containing chemical groups, an expression having the form “A¹-A³” refers to each A^{x} group within the range from A¹ to A³, inclusive of 1 and 3. For example, an expression having the form “A¹-A³” refers to A¹, A², and A³. An expression having the form “Z¹-Z³” refers to each Z^{x} group within the range from Z¹ to Z³, inclusive of 1 and 3. For example, an expression having the form “Z¹-Z³” refers to Z¹, Z², and Z³.

The term “independently selected” is used herein to indicate that the substituent groups, such as, Z¹, Z², Z³, and Z⁴, can be identical or different (e.g., Z¹, Z², Z³, and Z⁴ may all be —CH₃ or Z¹ and Z² may be —CH₃ and Z³ and Z⁴ may be —H, etc.). A chemical name associated with a substituent group is intended to convey the chemical structure that is recognized in the art as corresponding to that of the chemical name. Thus, chemical names are intended to supplement and illustrate, not preclude, the structural definitions known to those of skill in the art.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₂₀)hydrocarbyl is a hydrocarbyl group having from 1 to 20 carbon atoms in its unsubstituted form. In some embodiments and general structures, certain chemical groups may be substituted by one or more substituents such as R^{S}. An R^{S} substituted version of a chemical group defined using the “(Cₓ-C_{y})” parenthetical may contain more than y carbon atoms depending on the identity of any groups R^{S}. For example, a “(C₁-C₂₀)alkyl substituted with exactly one group R^{S}, where R^{S} is phenyl (—C₆H₅)” may contain from 7 to 27 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “—H” means a hydrogen or hydrogen radical that is covalently bonded to an atom other than hydrogen. “Hydrogen” and “—H” are interchangeable, and, unless clearly specified, have identical meanings.

The term “(C₁-C₃₀)hydrocarbyl” means a monovalent hydrocarbon of from 1 to 30 carbon atoms, in which each monovalent hydrocarbon is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S}, or unsubstituted. In this disclosure, a (C₁-C₃₀)hydrocarbyl may be an unsubstituted or substituted (C₁-C₃₀)alkyl, (C₃-C₃₀)cycloalkyl, or (C₆-C₃₀)aryl.

The term “(C₂-C₃₀)alkyl” mean a saturated straight or branched monovalent hydrocarbon of from 2 to 30 carbon atoms that is unsubstituted or substituted by one or more R^{S}. Examples of unsubstituted (C₂-C₃₀)alkyl are unsubstituted (C₂-C₂₀)alkyl; unsubstituted (C₆-C₂₅)alkyl; unsubstituted (C₄-C₈)alkyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₂-C₃₀)alkyl are substituted (C₂-C₂₀)alkyl, substituted (C₂-C₁₀)alkyl.

The term “(C₆-C₄₀)aryl” means an unsubstituted or substituted (by one or more R^{S}) monocyclic, bicyclic, or tricyclic aromatic monovalent hydrocarbon of from 6 to 40 carbon atoms, of which at least from 6 to 14 of the carbon atoms are aromatic ring carbon atoms. A monocyclic aromatic monovalent hydrocarbon includes one aromatic ring; a bicyclic aromatic monovalent hydrocarbon has two rings; and a tricyclic aromatic monovalent hydrocarbon has three rings. When the bicyclic or tricyclyc aromatic monovalent hydrocarbon is present, at least one of the rings of the monovalent hydrocarbon is aromatic. The other ring or rings of the aromatic monovalent hydrocarbon may be independently fused or non-fused and aromatic or non-aromatic. Examples of unsubstituted (C₆-C₄₀)aryl include: unsubstituted (C₆-C₂₀)aryl, unsubstituted (C₆-C₁₈)aryl; 2-(C₁-C₅)alkyl-phenyl; phenyl; fluorenyl; tetrahydrofluorenyl; idacenyl; hexahydracenyl; hexahydroindacenyl; indenyl; dihydroindenyl; naphthyl; tetrahydronaphthyl; and phenanthrene. Examples of substituted (C₆-C₄₀)aryl include: substituted (C₁-C₂₀)aryl; and substituted (C₆-C₁₈)aryl.

The term “(C₆-C₁₂)cycloalkyl” means a saturated cyclic monovalent hydrocarbon of from 6 to 12 carbon atoms that is unsubstituted or substituted. Other cycloalkyl groups (e.g., (Cₓ-C_{y})cycloalkyl) are defined in an analogous manner as having from x to y carbon atoms and being either unsubstituted or substituted by one or more R^{S}. Examples of unsubstituted (C₆-C₁₂)cycloalkyl are unsubstituted (C₆-C₈)cycloalkyl, unsubstituted (C₆-C₁₀)cycloalkyl, cyclopropyl, cyclobutyl, cyclopentyl, cyclohexyl, cycloheptyl, cyclooctyl, cyclononyl, and cyclodecyl. Examples of substituted (C₆-C₁₂)cycloalkyl are substituted (C₆-C₈)cycloalkyl, substituted (C₆-C₁₀)cycloalkyl, isobornyl, and 3,3,5-trimethylcyclohexyl.

The term “heteroatom,” refers to an atom other than hydrogen or carbon. Examples of heteroatoms include O, S, N, Si. The term “heterohydrocarbon” refers to a molecule or molecular framework in which one or more carbon atoms of a hydrocarbon are replaced with a heteroatom. The term “(C₁-C₃₀)heterohydrocarbyl” means a monovalent heterohydrocarbon of from 1 to 30 carbon atoms, and the term “(C₁-C₃₀)heterohydrocarbylene” means a divalent heterohydrocarbon of from 1 to 30 carbon atoms. The heterohydrocarbon of the (C₁-C₃₀)heterohydrocarbyl or the (C₁-C₃₀)heterohydrocarbylene has one or more heteroatoms. The valency or connection point of the heterohydrocarbyl may be on a carbon atom or a heteroatom. The two valencies of the heterohydrocarbylene may be on a single carbon atom or on a single heteroatom. Additionally, one of the two valencies or connection points of the diradical may be on a carbon atom and the other valency may be on a different carbon atom; one of the two valencies or connection points may be on a carbon atom and the other on a heteroatom; or one of the two valencies or connection points may be on a heteroatom and the other valency or connection point on a different heteroatom. Each (C₁-C₃₀)heterohydrocarbyl and (C₁-C₃₀)heterohydrocarbylene may be unsubstituted or substituted, aromatic or non-aromatic, saturated or unsaturated, straight chain or branched chain, cyclic (including mono- and poly-cyclic, fused and non-fused polycyclic), or acyclic.

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double and/or triple bonds optionally may or may not be present in substituents R^{S}. The term “unsaturated” means containing one or more carbon-carbon double bonds, carbon-carbon triple bonds, or (in heteroatom-containing groups) one or more carbon-nitrogen, carbon-phosphorous, or carbon-silicon double bonds, not including double bonds that may be present in substituents R^{S}, if any, or in (hetero) aromatic rings, if any.

The term “linker” means a multivalent group. A linker may connect at least two moieties of a compound together, in particular 2 to 16 moieties of a compound together. For example, a linker that connects two moieties of a compound together is referred to as a divalent linker and a linker that connects three moieties of a compound together is referred to as a trivalent linker.

### Oligomer

The curable compositions disclosed herein include an oligomer. The oligomers herein include at least one polymerized chromophore monomer unit, as defined herein. The oligomers herein further include at least one polymerized high-T_{g} monomer unit and at least one polymerized low T_{g} monomer unit. The oligomers herein optionally include at least one polymerized additional monomer unit, as defined herein. The oligomers herein may not comprise polymerized monomer units other than the polymerized high-T_{g} monomer units, the polymerized low T_{g} monomer unit, the polymerized chromophore monomer units, and the optional polymerized additional monomer units. The total weight of the polymerized high-T_{g} monomer units, the polymerized low T_{g} monomer unit, the polymerized chromophore monomer units, and the polymerized additional monomer units may represent at least 97%, in particular at least 98%, more particularly at least 99%, more particularly still 100% of the total weight of the oligomer.

Oligomers described herein can be formed by polymerization of the different monomer units (i.e. the high-T_{g} monomer units, the low-T_{g} monomer units, the chromophore monomer units, and optionally, the at least one additional monomer unit). Common methods known in the art include, but are not limited, to solution polymerization. Accordingly, the oligomer may be obtained by polymerizing the different monomer units dissolved in a non-reactive solvent in the presence of an initiator. The solution polymerization may be conducted at a temperature of at least 50° C., preferably at least 60° C. Examples of suitable non-reactive solvents include toluene, heptane, ethyl acetate, methyl ethyl ketone (MEK), isopropanol and combinations thereof. The initiator may be a thermal initiator. Thermal initiators are well known in the art and include, for example, peroxides (i.e., a compound comprising an oxygen-oxygen single bond), especially inorganic persulfate compounds such as ammonium persulfate, potassium persulfate and sodium persulfate; hydrogen peroxide; organic peroxides such as cumene hydroperoxide, t-butyl hydroperoxide, acetyl peroxide, benzoyl peroxide, lauroyl peroxide; peracids such as peracetic acid and perbenzoic acid; redox initiators wherein a reducing agent such as a ferrous compound promotes the decomposition of a peroxide; as well as other free radical producing materials such as an azo-initiator (i.e., a compound comprising an nitrogen-nitrogen double bond), for example 2,2′-azobisisobutyronitrile, 4,4′-azobis(4-cyanovaleric acid) or 2,2′-azobis(2-methylbutyronitrile); and combinations thereof. The initiator may be added in an amount such that the total monomer:initiator weight ratio is from 100:1 to 1000:1 The solution polymerization typically provides a mixture of the oligomer dissolved in the non-reactive solvent. The non-reactive solvent may be eliminated (i.e. by heating) once the oligomer has been combined with the low viscosity reactive diluent to form the curable composition of the invention. At the end of the solution polymerization (i.e. prior to the introduction of the low viscosity reactive diluent) the mixture may have a solids content of from 25% to 70%, preferably from 30% to 50%, by weight based on the total weight of the mixture. Said mixture may have a residual amount of monomers that is less than 2%, in particular less than 1%, more particularly less than 0.5%, by weight based on the total weight of the mixture. The experimental parameters of the solution polymerization (i.e. solids content, reaction temperature, reaction time and total monomer:initiator ratio) can be adjusted to produce oligomers of relatively low molecular weights using experimental conditions well known by those skilled in the art.

Preferably, the oligomer is not obtained by telomerization, i.e. in the presence of a telogen compound (i.e. a compound bearing at least one cleavable bond selected from C—H, S—H, P—H, Si—H or C—X, where X=Cl, Br or I) such as tetrabromomethane (CBr₄), bromotrichloromethane (CBrCl₃), dibromodichloromethane (CBr₂Cl₂), a mercaptan, hydrogen disulfide.

In embodiments, the oligomer may have a weight average molecular weight of at least 10,000 grams per mole (g/mol). In embodiments, the oligomer may have a weight average molecular weight from 10,000 g/mol to 600,000 g/mol. In embodiments, the oligomer may have a weight average molecular weight equal to or greater than 10,000 g/mol, equal to or greater than 25,000 g/mol, or even equal to or greater than 50,000 g/mol. In embodiments, the oligomer may have a weight average molecular weight equal to or less than 600,000 g/mol, equal to or less than 500,000 g/mol, equal to or less than 400,000 g/mol, equal to or less than 300,000 g/mol, equal to or less than 200,000 g/mol, or even equal to or less than 100,000 g/mol. In embodiments, the oligomer may have a weight average molecular weight from 10,000 g/mol to 600,000 g/mol, from 10,000 g/mol to 500,000 g/mol, from 10,000 g/mol to 400,000 g/mol, from 10,000 g/mol to 300,000 g/mol, from 10,000 g/mol to 200,000 g/mol, from 10,000 g/mol to 100,000 g/mol, from 25,000 g/mol to 600,000 g/mol, from 25,000 g/mol to 500,000 g/mol, from 25,000 g/mol to 400,000 g/mol, from 25,000 g/mol to 300,000 g/mol, from 25,000 g/mol to 200,000 g/mol, from 25,000 g/mol to 100,000 g/mol, from 50,000 g/mol to 600,000 g/mol, from 50,000 g/mol to 500,000 g/mol, from 50,000 g/mol to 400,000 g/mol, from 50,000 g/mol to 300,000 g/mol, from 50,000 g/mol to 200,000 g/mol, or even from 50,000 g/mol to 100,000 g/mol, or any and all subranges formed from any of these endpoints.

In a preferred embodiment, the oligomer may have a weight average molecular weight of from 10,000 g/mol to 100,000 g/mol, in particular from 10,000 g/mol to 50,000 g/mol, in particular from 11,000 g/mol to 49,000 g/mol, more particularly from 12,000 g/mol to 48,000 g/mol, even more particularly from 15,000 g/mol to 45,000 g/mol, more particularly still from 15,000 g/mol to 40,000 g/mol.

In embodiments, the oligomer may have a glass transition temperature T_{g} equal to or less than −10° C. to ensure the curable composition is suitable for certain applications, such as use as a pressure sensitive adhesive. In embodiments, the oligomer may have a T_{g} equal to or less than −10° C., such as equal to or less than −15° C., equal to or less than −20° C., equal to or less than −25° C., or even equal to or less than −30° C. In embodiments, the oligomer may have a T_{g} equal to or greater than −120° C., equal to or greater than −100° C., equal to or greater than −80° C., or even equal to or greater than −60° C. In embodiments, the oligomer may have a T_{g} from −10° C. to −120° C., from −10° C. to −100° C., from −10° C. to −80° C., from −10° C. to −60° C., from −15° C. to −120° C., from −15° C. to −100° C., from −15° C. to −80° C., from −15° C. to −60° C., from −20° C. to −120° C., from −20° C. to −100° C., from −20° C. to −80° C., from −20° C. to −60° C., from −25° C. to −120° C., from −25° C. to −100° C., from −25° C. to −80° C., from −25° C. to −60° C., from −30° C. to −120° C., from −30° C. to −100° C., from −30° C. to −80° C., or even from −30° C. to −60° C., or any and all subranges formed from any of these endpoints.

The amount of oligomer in the curable composition will vary depending on the desired viscosity. In embodiments, the curable composition may comprise, based on a weight of the curable composition, from 20% to 80% by weight of the oligomer. In embodiments, the curable composition may comprise, based on a weight of the curable composition, equal to or greater than 20%, equal to or greater than 25%, equal to or greater than 30%, equal to or greater than 35%, or even equal to or greater than 40%, by weight of the oligomer. In embodiments, the curable composition may comprise, based on a weight of the curable composition, equal to or less than 80%, equal to or less than 75%, equal to or less than 70%, equal to or less than 65%, or even equal to or less than 60%, by weight of the oligomer. In embodiments, the amount by weight of the oligomer in the curable composition, based on the total weight of the curable composition, may be from 20% to 80%, from 20% to 75%, from 20% to 70%, from 20% to 75%, from 20% to 60%, from 25% to 80%, from 20% to 75%, from 25% to 70%, from 25% to 75%, from 25% to 60%, from 30% to 80%, from 30% to 75%, from 30% to 70%, from 30% to 75%, from 30% to 60%, from 35% to 80%, from 35% to 75%, from 35% to 70%, from 35% to 75%, from 35% to 60%, from 40% to 80%, from 40% to 75%, from 40% to 70%, from 40% to 75%, or even from 40% to 60%, or any and all subranges formed from any of these endpoints.

In embodiments, the oligomer has formula (O):

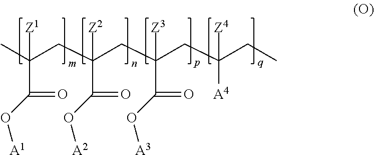

where:
   each A¹ is independently H, (C₁-C₃₀)hydrocarbyl or (C₁-C₃₀)heterohydrocarbyl, preferably H or (C₁-C₃₀)hydrocarbyl;
   each A² is independently (C₂-C₃₀)hydrocarbyl or (C₂-C₃₀)heterohydrocarbyl, preferably (C₄-C₃₀)hydrocarbyl;
   each A³ is independently a monovalent residue comprising the Norrish Type II chromophore;
   each A⁴ is independently a (C₁-C₃₀)hydrocarbyl or (C₁-C₃₀)heterohydrocarbyl;
   Z¹, Z², Z³, and Z⁴ are independently —H or —CH₃;
   m is a weight fraction of the polymerized high-T_{g} monomer units;
   n is a weight fraction of the polymerized low-T_{g} monomer units;
   p is a weight fraction of the polymerized chromophore monomer units; and
   q is a weight fraction of the at least one polymerized additional monomer units and optionally is zero; and
   m+n+p+q is equal to 1.

In the oligomer according to formula (O), m may be from 0.01 to 0.80; n may be from 0.10 to 0.989, p may be from 0.001 to 0.4, and q may be from 0 to 0.2.

In some embodiments, q is 0, whereby the polymerized additional monomer units are not present in the oligomer.

Further preferential recitations for A¹, A², A³, A⁴ Z¹, Z², Z³, Z⁴, m, n, p and q are defined below for each corresponding monomer unit.

High T_{g}. Monomer Units

The oligomers disclosed herein include polymerized high T_{g} monomer units. The high-T_{g} monomer units are distinct from the low-T_{g} monomer units, the chromophore monomer units and the additional monomer units. Accordingly, the high-T_{g} monomer units may not comprise any of the following groups:
a chromophore moiety
a functional group as defined below for the additional monomer units.

The polymerized high-T_{g} monomer units may be identical or a combination of multiple types of discrete monomer units such as two types of discrete monomer units, three types of discrete monomer units, four types of discrete monomer units, or more than four types of discrete monomer units. In embodiments, the high-T_{g} monomer units have a glass transition temperature (T_{g}) or a Fox Equation average T_{g} equal to or greater than 25° C. As defined herein, any reference herein to the T_{g} of a monomer refers to the T_{g} of a homopolymer formed from that monomer. In embodiments where the oligomer comprises two or more distinct high-T_{g} monomer units, such as a combination of methyl (meth)acrylate and isobornyl (meth)acrylate, the T_{g} refers to the Fox Equation average T_{g} of the high-T_{g} monomer units, as defined previously herein. In embodiments, the Fox Equation average T_{g} of the high-T_{g} monomer units is greater than 25° C., such as equal to or greater than 30° C., equal to or greater than 35° C., equal to or greater than 40° C., equal to or greater than 45° C., equal to or greater than 50° C., equal to or greater than 55° C., equal to or greater than 60° C., equal to or greater than 65° C., equal to or greater than 70° C., equal to or greater than 75° C., or even equal to or greater than 80° C. In embodiments, the high T_{g} monomer units may have a T_{g} equal to or less than 200° C., equal to or less than 150° C., or even equal to or less than 130° C. In embodiments, the high T_{g} monomer units may have a T_{g} from 25° C. to 200° C., from 25° C. to 150° C., from 25° C. to 130° C., from 30° C. to 200° C., from 30° C. to 150° C., from 30° C. to 130° C., from 35° C. to 200° C., from 35° C. to 150° C., from 35° C. to 130° C., from 40° C. to 200° C., from 40° C. to 150° C., from 40° C. to 130° C., from 45° C. to 200° C., from 45° C. to 150° C., from 45° C. to 130° C., from 50° C. to 200° C., from 50° C. to 150° C., from 50° C. to 130° C., from 55° C. to 200° C., from 55° C. to 150° C., from 55° C. to 130° C., from 60° C. to 200° C., from 60° C. to 150° C., from 60° C. to 130° C., from 65° C. to 200° C., from 65° C. to 150° C., from 65° C. to 130° C., from 70° C. to 200° C., from 70° C. to 150° C., from 70° C. to 130° C., from 75° C. to 200° C., from 75° C. to 150° C., or even from 75° C. to 130° C., or any and all subranges formed from any of these endpoints.

The Fox Equation average T_{g} of the high-T_{g} monomer units is greater than the Fox Equation average T_{g} of the low-T_{g} monomer units. In embodiments the Fox Equation average T_{g} of the high-T_{g} monomer units is at least 20° C. greater than the Fox Equation average T_{g} of the low-T_{g} monomer units. In embodiments, the difference between the Fox Equation average T_{g} of the high-T_{g} monomer units and the Fox Equation average T_{g} of the low-T_{g} monomer units is greater than 20° C., such as greater than 25° C., greater than 30° C., greater than 35° C., greater than 40° C., greater than 45° C., greater than 50° C., greater than 55° C., greater than 60° C., greater than 65° C., greater than 70° C., greater than 75° C., greater than 80° C., greater than 85° C., greater than 90° C., greater than 95° C., greater than 100° C., greater than 105° C., greater than 110° C., greater than 115° C., or even greater than 120° C. In embodiments, the difference between the Fox Equation average T_{g} of the high-T_{g} monomer units and the Fox Equation average T_{g} of the low-T_{g} monomer units is at least 200° C., at least 150° C., at least 120° C., at least 100° C., at least 90° C., at least 80° C., at least 70° C., at least 60° C., at least 50° C., at least 40° C., or even at least 30° C. In embodiments, the difference between the Fox Equation average T_{g} of the high-T_{g} monomer units and the Fox Equation average T_{g} of the low-T_{g} monomer units is from 20° C. to 200° C. As non-limiting examples the difference between the Fox Equation average T_{g} of the high-T_{g} monomer units and the Fox Equation average T_{g} of the low-T_{g} monomer units may be from 20° C. to 200° C., from 20° C. to 150° C., from 20° C. to 120° C., from 20° C. to 100° C., from 20° C. to 90° C., from 20° C. to 80° C., from 20° C. to 70° C., from 20° C. to 60° C., from 20° C. to 50° C., from 20° C. to 40° C., from 20° C. to 30° C., from 30° C. to 200° C., from 30° C. to 150° C., from 30° C. to 120° C., from 30° C. to 100° C., from 30° C. to 90° C., from 30° C. to 80° C., from 30° C. to 70° C., from 30° C. to 60° C., from 30° C. to 50° C., from 30° C. to 40° C., from 40° C. to 200° C., from 40° C. to 150° C., from 40° C. to 120° C., from 40° C. to 100° C., from 40° C. to 90° C., from 40° C. to 80° C., from 40° C. to 70° C., from 40° C. to 60° C., from 40° C. to 50° C., from 50° C. to 200° C., from 50° C. to 150° C., from 50° C. to 120° C., from 50° C. to 100° C., from 50° C. to 90° C., from 50° C. to 80° C., from 50° C. to 70° C., from 50° C. to 60° C., from 60° C. to 200° C., from 60° C. to 150° C., from 60° C. to 120° C., from 60° C. to 100° C., from 60° C. to 90° C., from 60° C. to 80° C., from 60° C. to 70° C., from 70° C. to 200° C., from 70° C. to 150° C., from 70° C. to 120° C., from 70° C. to 100° C., from 70° C. to 90° C., from 70° C. to 80° C., from 80° C. to 200° C., from 80° C. to 150° C., from 80° C. to 120° C., from 80° C. to 100° C., or even from 80° C. to 90° C., or any and all subranges formed from any of these endpoints.

The high T_{g} monomer units consist of one or more (meth)acrylate monomers, preferably one or more monofunctional (meth)acrylate monomers.

In embodiments, the high T_{g} monomer units are monovalent. In other embodiments, the high T_{g} monomer units may be multivalent, where the individual monomer unit comprises two or more active sites that participate in crosslinking upon curing. Examples of monovalent monomer units may include ethyl methacrylate and tert-butyl acrylate. Examples of multivalent monomer units may include divalent monomer units, such as dicyclopentadienyl acrylate.

In embodiments, each of the high T_{g} monomer units (prior to being polymerized into the backbone of the oligomer) may independently be according to formula (I):

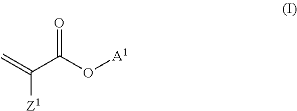

where:
   A¹ is H, (C₁-C₃₀)hydrocarbyl or (C₁-C₃₀)heterohydrocarbyl, preferably H or (C₁-C₃₀)hydrocarbyl; and
   Z¹ is —H or —CH₃.

For instance, in embodiments, A¹ may be chosen from H, methyl, ethyl, isopropyl, isobutyl, tert-butyl, a substituted or unsubstituted (C₆-C₁₂)cycloalkyl, or combinations thereof. In embodiments, A¹ may be chosen from H, methyl, tert-butyl, isobornyl, cyclohexyl, or 3,3,5-trimethylcyclohexyl, or combinations thereof.

Said embodiments equally apply to A¹ in the oligomer of formula (O).

Examples of suitable high T_{g} monomer units may include, but not be limited to, monomers units chosen from (meth)acrylic acid, 2-phenylethyl methacrylate, 3,3,5-trimethylcyclohexyl acrylate, tert-butyl acrylate, octadecyl methacrylate, octadecyl acrylate, propyl methacrylate, benzyl methacrylate, isobutyl methacrylate, ethyl methacrylate, 2,2,3,3-tetrafluoropropyl methacrylate, 2,2,2-trifluoroethyl methacrylate, isopropyl methacrylate, isobornyl acrylate, methyl methacrylate, isobornyl methacrylate, phenyl methacrylate, tert-butyl methacrylate, cyclohexyl methacrylate, 4-tert-butylcyclohexyl acrylate, 4-tert-butylcyclohexyl methacrylate, 3,3,5-trimethylcyclohexyl acrylate, 3,3,5-trimethylcyclohexyl methacrylate, a substituted or unsubstituted (C₆-C₁₂)cycloalkyl (meth)acrylate, adamantyl (meth)acrylate, tricyclodecane methanol mono(meth)acrylate, or combinations thereof.

Preferably, the high T_{g} monomer units of the oligomer are chosen from methyl methacrylate, tert-butyl (meth)acrylate, (meth)acrylic acid, isobornyl (meth)acrylate or combinations thereof. Alternatively, the high T_{g} monomer units of the oligomer are chosen from methyl methacrylate, acrylic acid, isobornyl acrylate and isobornyl methacrylate or combinations thereof.

More preferably, the high T_{g} monomer units of the oligomer are chosen from methyl methacrylate, tert-butyl acrylate or a mixture of methyl methacrylate and acrylic acid.

The weight fraction of the polymerized high T_{g} monomer units in the oligomer will vary depending on desired properties of the oligomer, such as T_{g}, molecular weight, and gel content after curing. In embodiments, the oligomer may comprise, based on the total weight of the oligomer, from 1% to 80% by weight polymerized high T_{g} monomer units. It should be understood that, when the oligomer includes more than one discrete type of polymerized high T_{g} monomer unit, the weight fraction of the polymerized high T_{g} monomer units in the oligomer equals the sum of the individual weight fractions of every discrete type of polymerized high T_{g} monomer unit in the oligomer.

In embodiments, the oligomer may comprise, based on the total weight of the oligomer, from 1% to 50%, or from 3% to 44% by weight of the polymerized high T_{g} monomer units. In embodiments, the oligomer may comprise, based on the total weight of the oligomer, equal to or greater than 1%, equal to or greater than 3%, equal to or greater than 5%, equal to or greater than 15 wt %, or even equal to or greater than 25 wt %, by weight of polymerized high T_{g} monomer units. In embodiments, the oligomer may comprise, based on the total weight of the oligomer, equal to or less than 80%, equal to or less than 70%, equal to or less than 60%, equal to or less than 50%, equal to or less than 44%, equal to or less than 30%, or even equal to or less than 20%, by weight of polymerized high T_{g} monomer units. In embodiments, the amount, by weight, of polymerized high T_{g} monomer units in the oligomer, based on the total weight of the oligomer, may be from 1% to 80%, from 1% to 70%, from 1% to 60%, from 1% to 50%, from 1% to 44%, from 1% to 30%, from 1% to 20%, from 3% to 80%, from 3% to 70%, from 3% to 60%, from 3% to 50%, from 3% to 44%, from 3% to 30%, from 3% to 20%, from 5% to 80%, from 5% to 70%, from 5% to 60%, from 5% to 50%, from 5% to 44%, from 5% to 30%, from 5% to 20%, from 15% to 80%, from 15% to 70%, from 15% to 60%, from 15% to 50%, from 15% to 44%, from 15% to 30%, from 15% to 20%, from 25% to 80%, from 25% to 70%, from 25% to 60%, from 25% to 50%, from 25% to 44%, or even from 25% to 30%, or any and all subranges formed from any of these endpoints.

The above values also correspond to the weight fraction m of the polymerized high-T_{g} monomer units in the oligomer of formula (O).

### Low T_{g} Monomer Units

The oligomers disclosed herein include low T_{g} monomer units. The low T_{g} monomer units are distinct from the high-T_{g} monomer units, the chromophore monomer units and the additional monomer units. Accordingly, the low-T_{g} monomer units may not comprise any of the following groups:
a chromophore moiety
a functional group as defined below for the additional monomer units.

The polymerized low-T_{g} monomer units may be identical or a combination of multiple types of discrete monomer units such as two types of discrete monomer units, three types of discrete monomer units, four types of discrete monomer units, or more than four types of discrete monomer units. In embodiments, the low T_{g} monomer units may have a glass transition temperature (T_{g}) less than 25° C. As defined herein, any reference herein to the T_{g} of a monomer refers to the T_{g} of a homopolymer formed from that monomer. In embodiments, the low T_{g} monomer units may have a T_{g} equal to or less than 25° C. or a Fox Equation average T_{g} less than 25° C. As defined herein, any reference herein to the T_{g} of a monomer refers to the T_{g} of a homopolymer formed from that monomer. In embodiments where the oligomer comprises two or more distinct low-T_{g} monomer units, the T_{g} refers to the Fox Equation average T_{g} of the low-T_{g} monomer units, as defined previously herein. In embodiments, the low-T_{g} monomer units have a Fox Equation average T_{g} of less than 25° C., such as less than 20° C., less than 15° C., less than 10° C., less than 5° C., less than 0° C., less than −5° C., less than −10° C., less than −15° C., less than −20° C., or less than −30° C.

In further embodiments, the the low T_{g} monomer units may have a Fox Equation average T_{g} equal to or greater than −150° C., equal to or greater than −125° C., equal to or greater than −100° C., equal to or greater than −80° C., or even equal to or greater than −60° C. In embodiments, the low T_{g} monomer units may have a T_{g} from −150° C. to 25° C., from −150° C. to 20° C., from −125° C. to 15° C., from −125° C. to 10° C., from −125° C. to 5° C., from −125° C. to 0° C., from −125° C. to −5° C., from −125° C. to −10° C., from −125° C. to −15° C., from −125° C. to −20° C., from −125° C. to −30° C., from −125° C. to 25° C., from −125° C. to 20° C., from −125° C. to 15° C., from −125° C. to 10° C., from −125° C. to 5° C., from −125° C. to 0° C., from −125° C. to −5° C., from −125° C. to −10° C., from −125° C. to −15° C., from −125° C. to −20° C., from −125° C. to −30° C., from −100° C. to 25° C., from −100° C. to 20° C., from −100° C. to 15° C., from −100° C. to 10° C., from −100° C. to 5° C., from −100° C. to 0° C., from −100° C. to −5° C., from −100° C. to −10° C., from −100° C. to −15° C., from −100° C. to −20° C., from −100° C. to −30° C., from −80° C. to 25° C., from −80° C. to 20° C., from −80° C. to 15° C., from −80° C. to 10° C., from −80° C. to 5° C., from −80° C. to 0° C., from −80° C. to −5° C., from −80° C. to −10° C., from −80° C. to −15° C., from −80° C. to −20° C., from −80° C. to −30° C., from −60° C. to 25° C., from −60° C. to 20° C., from −60° C. to 15° C., from −60° C. to 10° C., from −60° C. to 5° C., from −60° C. to 0° C., from −60° C. to −5° C., from −60° C. to −10° C., from −60° C. to −15° C., from −60° C. to −20° C., or even −60° C. to −30° C., or any and all subranges formed from any of these endpoints.

The low T_{g} monomer units consist of one or more (meth)acrylate monomers, preferably one or more monofunctional (meth)acrylate monomers.

In embodiments, the low T_{g} monomer units may be monovalent. In embodiments, the low T_{g} monomer units may include (meth)acrylate monomers, including acrylate monomers and methacrylate monomers. Examples of acrylate monomers include sec-butyl acrylate monomers and n-butyl acrylate monomers. Examples of methacrylate monomers include butyl methacrylate monomers and pentyl methacrylate monomers.

In embodiments, each of the low T_{g} monomer units (prior to being polymerized into the backbone of the oligomer) may independently be according to formula (II):

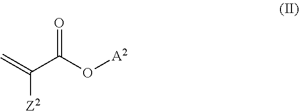

where:
   A² is (C₂-C₃₀)hydrocarbyl or (C₂-C₃₀)heterohydrocarbyl, preferably a (C₄-C₃₀)hydrocarbyl; and
   Z² is —H or —CH₃.

In embodiments, A² is a linear or branched (C₂-C₃₀)alkyl, preferably a linear or branched (C₄-C₃₀)alkyl. In embodiments, A² is chosen from n-butyl, isobutyl, hexyl, 2-ethylhexyl, isooctyl, isodecyl, tridecyl, lauryl, or combinations thereof.

Said embodiments equally apply to A² in the oligomer of formula (O).

Further examples of low T_{g} monomer units of the oligomer include, but are not limited to, monomer units chosen from n-butyl (meth)acrylate, isobutyl acrylate, hexyl (meth)acrylate, 2-ethylhexyl (meth)acrylate, isooctyl (meth)acrylate, isodecyl (meth)acrylate, tridecyl (meth)acrylate, lauryl (meth)acrylate, nonyl acrylate, decyl (meth)acrylate, octyl (meth)acrylate, propyl acrylate, isobutyl acrylate, 2,2,3,3-tetrafluoropropyl acrylate, ethyl acrylate, sec-butyl acrylate, dodecyl acrylate, tetradecyl (meth)acrylate, isopropyl acrylate, pentyl (meth)acrylate, benzyl acrylate, cyclohexyl acrylate, hexadecyl (meth)acrylate, 2-methylbutyl acrylate, 2-octyl acrylate, or combinations thereof.

Preferably, the low T_{g} monomer units of the oligomer are n-butyl acrylate.

The weight fraction of the polymerized low T_{g} monomer units in the oligomer will vary depending on desired properties of the oligomer, such as T_{g}, molecular weight, and gel content after curing. In embodiments, the oligomer may comprise, based on a total weight of the oligomer, from 10% to 98.9% by weight of polymerized low T_{g} monomer units. It should be understood that, when the oligomer includes more than one discrete type of polymerized low T_{g} monomer unit, the weight fraction of the polymerized low T_{g} monomer units in the oligomer equals the sum of the individual weight fractions of every discrete type of polymerized low T_{g} monomer unit in the oligomer.

In embodiments, the oligomer may comprise, based on a total weight of the oligomer, from 50% to 97%, or from 55% to 95%, by weight of polymerized low T_{g} monomer units. In embodiments, the oligomer may comprise, based on the total weight of the oligomer, equal to or greater than 10%, equal to or greater than 20%, equal to or greater than 30%, equal to or greater than 40%, equal to or greater than 50%, equal to or greater than 55%, equal to or greater than 60%, equal to or greater than 70%, or even equal to or greater than 80%, by weight of polymerized low T_{g} monomer units. In embodiments, the oligomer may comprise, based on the total weight of the oligomer, equal to or less than 98.9%, equal to or less than 97%, equal to or less than 95%, equal to or less than 85%, or even equal to or less than 75%, by weight of polymerized low T_{g} monomer units. In embodiments, the amount, by weight, of polymerized low T_{g} monomer units in the oligomer, based on the total weight of the oligomer, from 10% to 98.9%, from 10% to 97%, from 10% to 95%, from 10% to 85%, from 10% to 75%, from 20% to 98.9%, from 20% to 97%, from 20% to 95%, from 20% to 85%, from 20% to 75%, from 30% to 98.9%, from 30% to 97%, from 30% to 95%, from 30% to 85%, from 30% to 75%, from 40% to 98.9%, from 40% to 97%, from 40% to 95%, from 40% to 85%, from 40% to 75%, from 50% to 98.9%, from 50% to 97%, from 50% to 95%, from 50% to 85%, from 50% to 75%, from 55% to 98.9%, from 55% to 97%, from 55% to 95%, from 55% to 85%, from 55% to 75%, from 70% to 98.9%, from 70% to 97%, from 70% to 95%, from 70% to 85%, from 70% to 75%, from 80% to 98.9%, from 80% to 97%, from 80% to 95%, or even from 80% to 85%, or any and all subranges formed from any of these endpoints.

The above values also correspond to the weight fraction n of the polymerized low-T_{g} monomer units in the oligomer of formula (O).

The weight ratio of low T_{g} monomer units to high T_{g} monomer units may be adjusted depending on desired properties of the oligomer, such as T_{g} and gel content after curing. In embodiments, the weight ratio of low T_{g} monomer units to high T_{g} monomer units in the oligomer may be from 24:1 to 1.5:1, from 20:1 to 1.5:1, from 15:1 to 1.5:1, from 10:1 to 1.5:1, 24:1 to 3:1, from 20:1 to 3:1, from 15:1 to 3:1, from 10:1 to 3:1, 24:1 to 5:1, from 20:1 to 5:1, from 15:1 to 5:1, or even from 10:1 to 5:1, or any and all subranges formed from any of these endpoints.

### Chromophore Monomer Units

In addition to a combination of at least one polymerized high-T_{g} monomer unit and at least one polymerized low-T_{g} monomer unit, the oligomers further include at least one polymerized chromophore monomer unit. The chromophore monomer units are distinct from the high T_{g} monomer units, the low T_{g} monomer units and the additional monomer units.

The polymerized chromophore monomer units may act as a photoinitiator and induce curing of the oligomer upon radiation. A photoinitiator is generally a moiety that, on absorption of light, generates reactive species (ions or radicals) and initiates one or several chemical reactions or transformations.

Photoinitiators may include free-radical photoinitiators. The photoinitiator may be selected so that it is susceptible to activation by photons of the wavelength associated with the actinic radiation (e.g., ultraviolet radiation, visible light) intended to be used to cure a curable composition. Norrish Type II (i.e., non-cleavable) photoinitiator moieties do not break down upon excitation, thus providing fewer possibilities for the leaching of small molecules from the matrix composition. For reference, see e.g. A. Gilbert, J. Baggott: “Essentials of Molecular Photochemistry”, Blackwell, London, 1991). Excited non-cleavable photoinitiators do not break down to radicals upon excitation, but extract a hydrogen atom from an organic molecule or, more efficiently, extract an electron from an electron donor (such as an amine or a thiol). The electron transfer produces a radical anion on the photoinitiator and a radical cation on the electron donor. This is followed by proton transfer from the radical cation to the radical anion to produce two uncharged radicals; of these the radical on the electron donor is sufficiently reactive to abstract a hydrogen atom from most substrates.

The photoinitiator may be a chromophore. Benzophenones and related ketones such as thioxanthones, xanthones, anthraquinones, fluorenones, dibenzosuberones, benzils, and phenyl ketocoumarins are examples of Norrish Type II chromophores. Most amines with a C—H bond in α-position to the nitrogen atom and many thiols are electron donors. Some titanocenes are Norrish Type II chromophores within the scope of the chromophore monomers herein.

In embodiments, the polymerized chromophore monomer units are (meth)acrylate monomers having a pendent Norrish Type II chromophore. That is, the Norrish Type II chromophore is not positioned on the terminal ends of the monomers.

Any of the above-discussed Norrish Type II chromophores may be the pendent moiety of the chromophore monomer units of oligomer. In embodiments, the Norrish Type II chromophore is chosen from benzophenones, thioxanthones, or titanocenes. In a specific example, the Norrish Type II chromophore is a benzophenone.

In embodiments, each of the chromophore monomer units (prior to being polymerized into the backbone of the oligomer) may independently be according to formula (III):

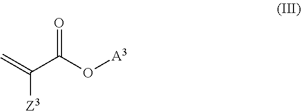

wherein
A³ is a monovalent residue comprising the Norrish Type II chromophore, in particular A³ is
X or -L-X;
L is a (C₁-C₁₀)heterohydrocarbylene linker;
X is a monovalent residue of a Norrish Type II chromophore;
Z³ is —H or —CH₃.

In embodiments, A³ of formula (III) is X or -L-X, where L is a (C₁-C₁₀)heterohydrocarbylene linker and X is a monovalent residue of the Norrish Type II chromophore. As used in this disclosure, the term “residue” shall mean the product of a reactant, such as the moiety remaining from a monomer in a polymer like a portion of a Norrish Type II chromophore. In other embodiments, A³ is a monovalent residue of the Norrish Type II chromophore. In embodiments, X may be a monovalent residue of any one of the above-discussed Norrish Type II chromophores. In embodiments, A³ is a monovalent residue of benzophenone. In embodiments, A³ has formula (IV):

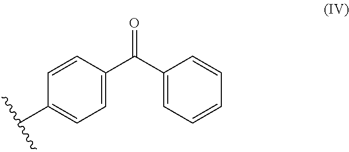 [SMILES: *c1ccc(C(=O)c2ccccc2)cc1]

Examples of suitable chromophore monomer units may include, but not be limited to (meth)acrylates of Norrish Type II photoinitiators such as benzophenone or thioxanthone.

In embodiments, A³ of formula (III) is a residue comprising a monovalent radical comprising a moiety chosen from a thioxanthone, an anthraquinone, or a camphorquinone. According to one or more embodiments, A³ is a residue comprising a monovalent radical comprising a thioxanthone.

In particular, A³ of formula (III) may have the following formula (V) or (VI):

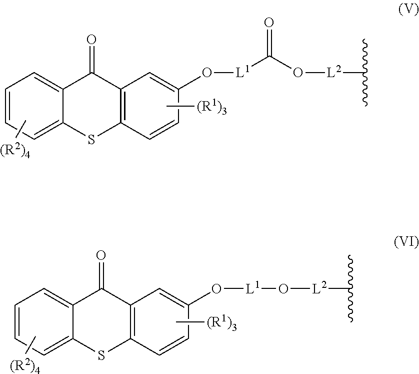

wherein, in formula (V) and formula (VI):
   L¹ is an alkylene;
   L² is a divalent linker comprising at least 2 carbon atoms;
   each R¹ and R² are independently selected from —H, halogen, alkyl, cycloalkyl, heterocycloalkyl, alkoxy, aryloxy, thioalkyl, thioaryl, alkenyl, alkynyl, aryl, aralkyl, alkaryl, heteroaryl, —C(═O)R^{a}, —NR^{b}R^{c}, alkylamino, alkylthiol, haloalkyl, —NO₂, —CN, —C(═O)OR^{d}, —C(═O)NR^{b}R^{c};
R^{a} is selected from an optionally substituted alkyl, an optionally substituted cycloalkyl, an optionally substituted heterocycloalkyl and an optionally substituted aryl;
R^{b}, R^{c} and R^{d} are independently selected from —H, alkyl and aryl;

In particular, in formula (V) and formula (VI), R¹ and R² are independently —H, halogen, alkyl or alkoxy. More particularly, R¹ and R² are independently H or alkyl. Even more particularly R¹ and R² are independently H or methyl. More particularly still, R¹ and R² are all —H.

In formula (V) and formula (VI), L¹ is an alkylene. In particular, each L¹ may independently be a linear or branched alkylene having from 1 to 6, from 1 to 4 or from 1 to 2 carbon atoms. More particularly, L¹ is —CH₂— or —CH(CH₃)—. Even more particularly, L¹ is —CH₂—.

In formula (V) and formula (VI), L² is a divalent linker comprising at least 2 carbon atoms. L² may be an aromatic, aliphatic or cycloaliphatic hydrocarbon linker, a polyether linker, a polyester linker, a polycarbonate linker, a polycaprolactone linker, a polyurethane linker, a polyorganosiloxane linker, a polybutadiene linker, and combinations thereof. In particular, L² may be selected from an aromatic, aliphatic or cycloaliphatic hydrocarbon linker, a polyether linker, a polyester linker and combinations thereof.

In formula (V) and formula (VI), L² may be —CH₂—CH(OH)—CH₂— or the residue of a diol. As used herein, the term “residue of a diol” means the linker obtained by removing two OH groups from a diol. Examples of suitable diols include 1,3-propylene glycol, 1,3- or 1,4-butylene glycol, 1,5-pentanediol, 1,6-hexanediol, 1,8-octanediol, 1,9-nonanediol, 1,10-decanediol, 1,12-dodecanediol, 2-methyl-1,3-propanediol, 2,2-diethyl-1,3-propanediol, 3-methyl-1,5-pentanediol, 3,3-dimethyl-1,5-pentanediol, neopentyl glycol, 2,4-diethyl-1,5-pentanediol, cyclohexanediol, cyclohexane-1,4-dimethanol, norbornene dimethanol, norbornane dimethanol, tricyclodecanediol, tricyclodecane dimethanol, bisphenol A, B, F or S, hydrogenated bisphenol A, B, F or S, di-, tri- or tetraethylene glycol, di-, tri- or tetrapropylene glycol, di-, tri- or tetrabutylene glycol, a polyethylene glycol, a polypropylene glycol, a polytetramethylene glycol, a poly(ethylene glycol-co-propylene glycol), a dianhydrohexitol (i.e. isosorbide, isomannide, isoidide), a polybutadiene polyol, a polyester polyol, a polyether polyol, a polyorganosiloxane polyol, a polycarbonate polyol as well as the alkoxylated (e.g., ethoxylated and/or propoxylated) derivatives thereof and the derivatives obtained by ring-opening polymerization of F-caprolactone initiated with one of the aforementioned polyols.

In formula (V) and formula (VI), L² may be —CH₂—CH(OH)—CH₂— or a divalent linker selected from one of formulas (A)-(E):

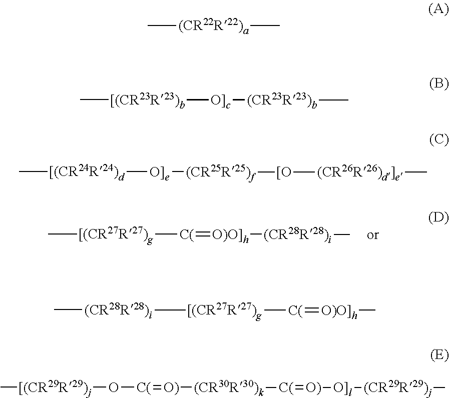

wherein
   R²², R′²². R²⁵, R′²⁵, R²⁹, R′²⁹, R³⁰ and R′³⁰ are independently H or alkyl;
   R²³, R′²³, R²⁴, R′²⁴, R²⁶, R′²⁶, R²⁷, R′²⁷, R²⁸ and R′²⁸ are independently H or methyl;
   a is 2 to 20;
   b, d, and d′ are independently 2 to 4;
   c is 1 to 20;
   e and e′ are independently 0 to 20 with the proviso that at least one of q and q′ is not 0;
   f is 2 to 20;
   g is 3 to 12;
   h is 1 to 20;
   I is 2 to 8;
   j is 2 to 20;
   k is 2 to 30;
   l is 1 to 20.

In particular, in formula (V) and formula (VI), L² may be —CH₂—CH(OH)—CH₂— or a divalent linker selected from an alkylene such as 1,3-propanediyl, 1,3- or 1,4-butanediyl, 1,5-pentanediyl, 1,6-hexanediyl, 1,8-octanediyl, 1,9-nonanediyl, 1,10-decanediyl, 1,12-decanediyl, 2-methyl-1,3-propanediyl, 2,2-diethyl-1,3-propanediyl, 3-methyl-1,5-pentanediyl, 3,3-dimethyl-1,5-pentanediyl, 2,2-dimethyl-1,3-propanediyl, 2,4-diethyl-1,5-pentanediyl; an alkoxylated (in particular an ethoxylated and/or propoxylated) derivative of the aforementioned alkylenes; an esterified (in particular by ring-opening polymerization of a lactone such as F-caprolactone) derivative of the aforementioned alkylenes; a residue of a di-, tri-, tetra- or polyoxyalkene without the OH groups such as di-, tri- or tetraethylene glycol, di-, tri- or tetrapropylene glycol, di-, tri- or tetrabutylene glycol, polyethylene glycol, polypropylene glycol, polybutylene glycol, poly(ethylene glycol-co-propylene glycol).

In some embodiments, A³ of formula (III) is according to one of the following formulas (Va) or (Vb):

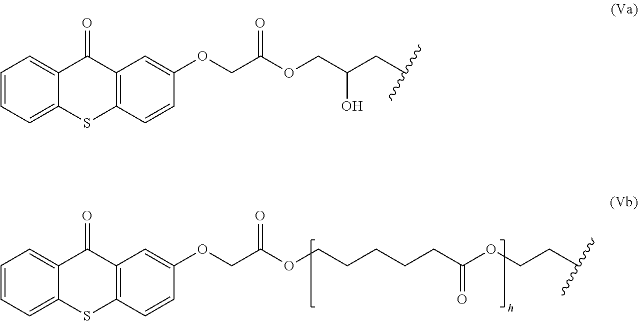

wherein h is 1 to 20.

Other suitable linker groups may be used, including others not including a carbonyl group.

All of the embodiments described above for A³ of formula (III) equally apply to A³ in the oligomer of formula (O). The weight fraction of the polymerized chromophore monomer units in the oligomer will vary depending on factors that are known in the art, such as desired cure time among other factors. In embodiments, the oligomer may comprise, based on the total weight of the oligomer, at least 0.1% by weight polymerized chromophore units to ensure improved peel strength. In embodiments, the oligomer may comprise, based on the total weight of the oligomer, from 0.1% to 40% by weight polymerized chromophore monomer units. It should be understood that, when the oligomer includes more than one discrete type of polymerized chromophore monomer unit, the weight fraction of the polymerized chromophore monomer units in the oligomer equals the sum of the individual weight fractions of every discrete type of polymerized chromophore monomer unit. Furthermore, it should be understood that, even if a chromophore monomer unit may be characterized based on T_{g} alone as a high T_{g} monomer or a low T_{g} monomer, any monomer including a pendant chromophore is considered to be neither a high T_{g} monomer nor a low T_{g} monomer with respect to calculating the weight fractions of the various monomers the oligomer of formula (O).

In embodiments, the oligomer may comprise, based on the total weight of the oligomer, from 0.1 to 10%, in particular from 0.1% to 2%, by weight of polymerized chromophore monomer units. In embodiments, the oligomer may comprise, based on the total weight of the oligomer, equal to or greater than 0.1%, equal to or greater than 0.25%, equal to or greater than 0.5%, or even equal to or greater than 1%, by weight of polymerized chromophore monomer units. In embodiments, the oligomer may comprise, based on the total weight of the oligomer, equal to or less than 40%, equal to or less than 30%, equal to or less than 20%, equal to or less than 10%, equal to or less than 5%, equal to or less than 2%, or even equal to or less than 1%, by weight of polymerized chromophore monomer units. In embodiments, the amount, by weight, of polymerized chromophore monomer units in the oligomer, based on the total weight of the oligomer, may be from 0.1% to 40%, from 0.1% to 30%, from 0.1% to 20%, from 0.1% to 10%, from 0.1% to 5%, from 0.1% to 2%, from 0.1% to 1%, from 0.25% to 40%, from 0.25% to 30%, from 0.25% to 20%, from 0.25% to 10%, from 0.25% to 5%, from 0.25% to 2%, from 0.25% to 1%, from 0.5% to 40%, from 0.5% to 30%, from 0.5% to 20%, from 0.5% to 10%, from 0.5% to 5%, from 0.5% to 2%, from 0.5% to 1%, from 1% to 40%, from 1% to 30%, from 1% to 20%, from 1% to 10%, from 1% to 5%, or even from 1% to 2%, or any and all subranges formed from any of these endpoints.

In a preferred embodiment, the amount, by weight, of polymerized chromophore monomer units in the oligomer, based on the total weight of the oligomer is from 0.5% to 30%, in particular from 0.5% to 20%, more particularly from 0.5% to 15%; even more particularly from 0.5% to 10%, more particularly yet from 1% to 10%.

The above values also correspond to the weight fraction p of the polymerized chromophore monomer units in the oligomer of formula (0).

### Additional Monomer Units

The oligomers disclosed herein optionally include at least one polymerized additional monomer units. The additional monomer units are distinct from the high-T_{g} monomer units, the low T_{g} monomer units and the chromophore monomer units.

The additional monomer units can include monomer units that are copolymerized with the high-T_{g} monomer units, the low-T_{g} monomer units, and the chromophore monomer units.

The additional monomer units may comprise a functional group selected from a polymerizable group other than a (meth)acrylate group (i.e. a vinyl group, an allyl group, a conjugated diene group, an alkenyl group), an acidic group (i.e. a carboxylic acid group other than the carboxylic acid group of (meth)acrylic acid, a phosphonic acid (—P(═O)(OH)₂) group, a phosphonate (—P(═O)(OR)₂) group, a sulfonic acid (—S(═O)₂OH) group, a sulfonate (—S(═O)₂OR) group, a phosphate (—O—P(═O)(OR)₂) group, wherein each R is independently a counterion, a hydrogen atom, or an optionally substituted hydrocarbyl), a nitrogen-containing group (i.e. an amino group, a cyano group or a heterocycle with one or more nitrogen ring atoms), a hydroxyl group, an epoxy group, a carbonyl group, an acetoacetoxy group, an acetoacetamide group, a 1,1-dimethyl-3-oxobuyl (diacetone) group, a thiol group, a silane group, an ether bond, an ester bond (not comprised in a (meth)acrylate group) and combinations thereof.

It should be highlighted that (meth)acrylic acid corresponds to a high T_{g} monomer. Accordingly, the amount by weight of polymerized (meth)acrylic acid units, if present, should be taken into account in the total amount of polymerized high-T_{g} monomer units and not in the total amount of polymerized additional monomer units.

In embodiments, additional monomer units can include monomer units other than (meth)acrylic monomer units, such as vinyl amides, vinyl ethers, vinyl esters, vinyl oxazolidinones, (meth)acrylamides, and combinations thereof. In embodiments, the additional monomer units can include other monomer units that are polymerized in the oligomer such as styrene derivatives and maleimides.

In embodiments, the additional monomer units can comprise epoxy, ether, ester, acid, or ketone functionality that are not polymerized in the oligomer. For example, the additional monomer units may comprise a caprolactone-extended acrylate (SR495B, Sartomer), cyclic trimethylolpropane formal acrylate (SR531, Sartomer) propoxylated tetrahydrofurfuryl acrylate (SR611, Sartomer), beta-carboxyethylacrylate, glycidyl methacrylate, or 2-(2-ethoxyethoxy)ethyl acrylate (SR256), neopentyl monomethacrylate, tetrahydrofurfuryl (meth)acrylate, phenoxyethyl acrylate, 2-hydroxypropyl (meth)acrylate, 2-hydroxyethyl (meth)acrylate, 2-cyanobutyl acrylate, 4-cyanobutyl acrylate, 2-cyanoethyl acrylate, cyanomethyl acrylate, and combinations thereof.

In embodiments, the additional monomer units can be a monomer that acts synergistically with the polymerized chromophore monomer units and/or reduces oxygen inhibition. Oxygen inhibition may limit surface curing and hence limit the performances of a resulting cured product.

Common synergist functionality that functions as a synergist for a Type II photoinitiator may include tertiary amine functionality, alkylenoxy functionality, mercaptan groups, or other sources of readily abstractable hydrogen. Typical damantly 1 monomer units which contain synergist functionality are exemplified by monomers such as dimethylaminoethyl acrylate (DMAEA), dimethylaminoethyl methacrylate (DMAEMA), diethylaminoethyl acrylate (DEAEA), diethylaminoethyl methacrylate (DEAEMA), N-vinylpyrrolidone (NVP), N-vinylcaprolactam (VCAP), acryloylmorpholine (ACMO), dimethyl acrylamide (DMAC), a poly(ethyleneoxide) mono(meth)acrylate, hydroxyethyl ethylene urea (meth)acrylate (HEEU(M)A), the reaction product of a cyclic anhydride with a hydroxy-functional (meth)acrylate, and combinations thereof.

In embodiments, the additional monomer units can comprise an amine synergist. Some examples of amine synergists include tertiary amines. When an amine-synergist containing monomer is included in the oligomer in conjunction with the Norrish Type II chromophore of the polymerized chromophore monomer unit, the tertiary amine provides an active hydrogen donor site for the excited triple state of the chromophore, thus producing a reactive alkyl-amino radical that subsequently can initiate polymerization. Tertiary amines are also able to convert unreactive peroxy species, formed by reaction between oxygen and free radicals, to reactive alkyl-amino radicals, thus reducing the effects of oxygen on curing.

In embodiments, the additional monomer units may be chosen from (meth)acrylate monomers having a pendent amine functionality. In embodiments, the additional monomer units are (meth)acrylate monomers having a pendent amine functionality.

Examples of amine synergists that may be the additional monomer of the oligomer include, but are not limited to, dimethylaminoethyl acrylate, dimethylaminoethylmethacrylate, diethylaminoethyl acrylate, acryloylmorpholine, dimethylacrylamide, monoacrylated poly ethylene glygol, monoacrylated propylene glycol, N-vinylpyrrolidone, or combinations thereof. Further examples of suitable amine synergists that may be the additional monomer of the oligomer include low-molecular weight tertiary amines (i.e. tertiary amines having a molecular weight of less than 200 g/mol) such as triethanol amine, N-methyldiethanol amine. Other types of amine synergists are aminobenzoates, polymerizable aminobenzoates, polymeric aminobenzoates, and mixtures thereof. Examples of aminobenzoates include ethyl 4-(dimethylamino)benzoate (EDB), pentyl 4-(dimethylamino)benzoate, 2-ethylhexyl 4-(dimethylamino)benzoate and 2-butoxyethyl 4-(dimethylamino)benzoate (BEDB).

In embodiments, the additional monomer units are (meth)acrylate monomers having a pendent amine functionality.

Any of the above-discussed synergists or amine-based synergists may be the pendent residue in the additional monomer units of the oligomers herein.

In embodiments, each of the additional monomer units (prior to being polymerized into the backbone of the oligomer) may independently be according to formula (VI):

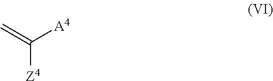

where:
   A⁴ is a (C₁-C₃₀)hydrocarbyl or (C₁-C₃₀)heterohydrocarbyl, preferably a (C₁-C₃₀)heterohydrocarbyl bearing a functional group selected from an acidic group, a nitrogen-containing group, a hydroxyl group, an epoxy group, a carbonyl group, an acetoacetoxy group, an acetoacetamide group, a 1,1-dimethyl-3-oxobuyl (diacetone) group, a thiol group, a silane group, an ether bond, an ester bond, and combinations thereof
   Z⁴ is —H or —CH₃.

A⁴ may comprise a monovalent residue of any one of the above-discussed synergists. In embodiments, Z⁴ is —H or —CH₃ and A⁴ is —C(═O)—O—R⁴ wherein R⁴ is selected from H, dimethylaminomethyl, dimethylaminoethyl, morpholino, dimethylamino, —CH₂—CH₂— imidazolidinone, or combinations thereof. In embodiments, Z⁴ is —H and A⁴ comprises a heterocycle bearing one or more nitrogen ring atoms, for example A⁴ may correspond to one of the following formulae:

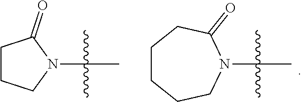 [SMILES: *N1CCCC1=O ; *N1CCCCCC1=O]

Said embodiments equally apply to A⁴ and Z⁴ in the oligomer of formula (O).

The weight fraction of the polymerized additional monomer units in the oligomer will vary depending on factors well-known in the art, such as desired cure time and desired extent of cure. In embodiments, the oligomer may comprise, based on the total weight of the oligomer, from 0% to 20% by weight polymerized additional monomer units. In embodiments, the oligomer may comprise, based on the total weight of the oligomer, equal to or greater than 0%, equal to or greater than 0.5%, equal to or greater than 1%, or even equal to or greater than 3%, by weight polymerized additional monomer units. In embodiments, the oligomer may comprise, based on the total weight of the oligomer, equal to or less than 20%, equal to or less than 15%, equal to or less than 10%, or even equal to or less than 5%, by weight polymerized additional monomer units. In embodiments, the amount, by weight, of polymerized additional monomer units in the oligomer, based on the total weight of the oligomer, may be from 0% to 20%, from 0% to 15%, from 0% to 10%, from 0% to 5%, from 0.5% to 20%, from 0.5% to 15%, from 0.5% to 10%, from 0.5% to 5%, from 1% to 20%, from 1% to 15%, from 1% to 10%, from 1% to 5%, from 3% to 20%, from 3% to 15%, from 3% to 10%, or even from 3% to 5%, or any and all subranges formed from any of these endpoints.

Preferably, the amount, by weight, of polymerized additional monomer units in the oligomer, based on the total weight of the oligomer, may be from 0% to 20%, in particular from 0 to 10%.

### Low Viscosity Reactive Diluent

The curable compositions disclosed herein include a low viscosity reactive diluent, which may be used with or completely replace a solvent.

In embodiments, the low viscosity reactive diluent may have a viscosity equal to or less than 3000 cP, as measured by Brookfield DV-III viscometer using Spindle SC-27 at 25° C., such as equal to or less than 2750 cP, equal to or less than 2500 cP, equal to or less than 2250 cP, equal to or less than 2000 cP, equal to or less than 1750 cP, equal to or less than 1500 cP, or even equal to or less than 1250. In embodiments, the low viscosity reactive diluent may have a viscosity equal to or greater than 5 cP, as measured by Brookfield DV-III viscometer using Spindle SC-27 at 25° C., such as equal to or greater than 25 cP, equal to or greater than 50 cP, equal to or greater than 100 cP, equal to or greater than 250 cP, equal to or greater than 500 cP, equal to or greater than 750 cP, or even equal to or greater than 1000 cP. In embodiments, the low viscosity reactive diluent may have a viscosity, as measured by Brookfield DV-III viscometer using Spindle SC-27 at 25° C., from 25 cP to 3000 cP, from 25 cP to 2750 cP, from 25 cP to 2500 cP, from 25 cP to 2250 cP, from 25 cP to 2000 cP, from 25 cP to 1750 cP, from 25 cP to 1500 cP, from 25 cP to 1250 cP, from 25 cP to 3000 cP, from 25 cP to 2750 cP, from 25 cP to 2500 cP, from 25 cP to 2250 cP, from 25 cP to 2000 cP, from 25 cP to 1750 cP, from 25 cP to 1500 cP, from 25 cP to 1250 cP, from 50 cP to 3000 cP, from 50 cP to 2750 cP, from 50 cP to 2500 cP, from 50 cP to 2250 cP, from 50 cP to 2000 cP, from 50 cP to 1750 cP, from 50 cP to 1500 cP, from 50 cP to 1250 cP, from 100 cP to 3000 cP, from 100 cP to 2750 cP, from 100 cP to 2500 cP, from 100 cP to 2250 cP, from 100 cP to 2000 cP, from 100 cP to 1750 cP, from 100 cP to 1500 cP, from 100 cP to 1250 cP, from 250 cP to 3000 cP, from 250 cP to 2750 cP, from 250 cP to 2500 cP, from 250 cP to 2250 cP, from 250 cP to 2000 cP, from 250 cP to 1750 cP, from 250 cP to 1500 cP, from 250 cP to 1250 cP, from 500 cP to 3000 cP, from 500 cP to 2750 cP, from 500 cP to 2500 cP, from 500 cP to 2250 cP, from 500 cP to 2000 cP, from 500 cP to 1750 cP, from 500 cP to 1500 cP, from 500 cP to 1250 cP, from 750 cP to 3000 cP, from 750 cP to 2750 cP, from 750 cP to 2500 cP, from 750 cP to 2250 cP, from 750 cP to 2000 cP, from 750 cP to 1750 cP, from 750 cP to 1500 cP, from 750 cP to 1250 cP, from 1000 cP to 3000 cP, from 1000 cP to 2750 cP, from 1000 cP to 2500 cP, from 1000 cP to 2250 cP, from 1000 cP to 2000 cP, from 1000 cP to 1750 cP, from 1000 cP to 1500 cP, or even from 1000 cP to 1250 cP, or any and all subranges formed from any of these endpoints.

The low viscosity reactive diluent may comprise at least one radically polymerizable diluent. The low viscosity reactive diluent may comprise a mixture of radically polymerizable diluents. When the low viscosity reactive diluent comprises a mixture of radically polymerizable diluents, the requirement relating to the viscosity applies to the mixture of the radically polymerizable diluents. Accordingly, the mixture may comprise a radically polymerizable diluent having a viscosity, as measured according to the method defined above, that is higher than 3000 cP at 25° C., as long as the final mixture of radically polymerizable diluents has a viscosity that is equal to or less than 3000 cP at 25° C.

As used herein, a radically polymerizable diluent is a compound having at least one polymerizable carbon-carbon double bond and a suitable viscosity as defined above. A polymerizable carbon-carbon double bond is capable of participating in a free radical polymerization wherein at least one of the carbon atoms of the double bond becomes covalently bonded to another atom, in particular a carbon atom, in a second molecule. In particular, the low viscosity reactive diluent may comprise at least one radically polymerizable diluent selected from a (meth)acrylate, a vinyl ether, a vinyl amide, a vinyl oxazolidinone, and combinations thereof. These diluents can be monofunctional (i.e. bear a single polymerizable carbon-carbon double bond) or multifunctional (i.e. bear at least two polymerizable carbon-carbon double bonds). These diluents can be selected to provide targeted final properties of the cured formulations as long as they provide adequate viscosity reduction of the oligomer while also producing adequate properties when curable composition is cured.

The low viscosity reactive diluent may comprise a monofunctional (meth)acrylate (i.e. a monomer bearing a single (meth)acrylate group). Examples of suitable monofunctional (meth)acrylates include mono-(meth)acrylate esters of aliphatic alcohols (wherein the aliphatic alcohol may be straight chain, branched or alicyclic and may be a mono-alcohol, a di-alcohol or a polyalcohol, provided only one hydroxyl group is esterified with (meth)acrylic acid); mono-(meth)acrylate esters of aromatic alcohols (such as phenols, including alkylated phenols); mono-(meth)acrylate esters of alkylaryl alcohols (such as benzyl alcohol); mono-(meth)acrylate esters of oligomeric and polymeric glycols such as diethylene glycol, triethylene glycol, dipropylene glycol, tripropylene glycol, polyethylene glycol, and polypropylene glycol); mono-(meth)acrylate esters of monoalkyl ethers of glycols and oligoglycols; mono-(meth)acrylate esters of alkoxylated (e.g., ethoxylated and/or propoxylated) aliphatic alcohols (wherein the aliphatic alcohol may be straight chain, branched or alicyclic and may be a mono-alcohol, a di-alcohol or a polyalcohol, provided only one hydroxyl group of the alkoxylated aliphatic alcohol is esterified with (meth)acrylic acid); mono-(meth)acrylate esters of alkoxylated (e.g., ethoxylated and/or propoxylated) aromatic alcohols (such as alkoxylated phenols); caprolactone mono(meth)acrylates; and the like. The following compounds are specific examples of mono(meth)acrylate-functionalized monomers suitable for use: methyl (meth)acrylate; ethyl (meth)acrylate; n-propyl (meth)acrylate; n-butyl (meth)acrylate; isobutyl (meth)acrylate; n-hexyl (meth)acrylate; 2-ethylhexyl (meth)acrylate; n-octyl (meth)acrylate; isooctyl (meth)acrylate; n-decyl (meth)acrylate; n-dodecyl (meth)acrylate; tridecyl (meth)acrylate; tetradecyl (meth)acrylate; hexadecyl (meth)acrylate; 2-hydroxyethyl (meth)acrylate; 2- and 3-hydroxypropyl (meth)acrylate; 2-methoxyethyl (meth)acrylate; 2-ethoxyethyl (meth)acrylate; 2- and 3-ethoxypropyl (meth)acrylate; tetrahydrofurfuryl (meth)acrylate; alkoxylated tetrahydrofurfuryl (meth)acrylate; 2-(2-ethoxyethoxy)ethyl (meth)acrylate; cyclohexyl (meth)acrylate; glycidyl (meth)acrylate; isodecyl (meth)acrylate; lauryl (meth)acrylate; 2-phenoxyethyl (meth)acrylate; alkoxylated phenol (meth)acrylates; alkoxylated nonylphenol (meth)acrylates; cyclic trimethylolpropane formal (meth)acrylate; isobornyl (meth)acrylate; tricyclodecanemethanol (meth)acrylate; tert-butylcyclohexanol (meth)acrylate; trimethylcyclohexanol (meth)acrylate; diethylene glycol monomethyl ether (meth)acrylate; diethylene glycol monoethyl ether (meth)acrylate; diethylene glycol monobutyl ether (meth)acrylate; triethylene glycol monoethyl ether (meth)acrylate; ethoxylated lauryl (meth)acrylate; methoxy polyethylene glycol (meth)acrylates; hydroxyl ethyl-butyl urethane (meth)acrylates; 3-(2-hydroxyalkyl)oxazolidinone (meth)acrylates; and combinations thereof.

Preferably, the low viscosity reactive diluent may comprise a monofunctional (meth)acrylate bearing one or more of the following groups: a ring or ring system (i.e. one or more rings selected from aromatic rings and/or (hetero)cycloaliphatic rings which may be fused and/or bridged), a C7-C20 hydrocarbon chain (i.e. a linear or branched chain bearing only carbon and hydrogen atoms wherein the number of carbon atoms in the chain is from 7 to 20), one or more oxyalkylene units (such as oxyethylene, oxypropylene and/or oxybutylene units), one or more ester units derived from the ring-opening of a lactone (such as F-caprolactone) and combinations thereof. Examples of such monofunctional (meth)acrylates are isobornyl (meth)acrylate, tetrahydrofurfuryl (meth)acrylate, phenol (meth)acrylate, nonylphenol (meth)acrylate, octyl (meth)acrylate, isooctyl (meth)acrylate, 2-ethylhexyl (meth)acrylate, decyl (meth)acrylate, isodecyl (meth)acrylate; lauryl (meth)acrylate; tridecyl (meth)acrylate, stearyl (meth)acrylate, a (poly)caprolactone mono(meth)acrylate, di-, tri-, tetra- or polyethylene glycol mono(meth)acrylate, di-, tri-, tetra- or polyethylene glycol monomethyl ether (meth)acrylate, di-, tri-, tetra- or polyethylene glycol monoethyl ether (meth)acrylate, as well as the alkoxylated (i.e. ethoxylated and/or propoxylated) derivatives thereof, and combinations thereof.

The low viscosity reactive diluent may comprise a polyfunctional (meth)acrylate (i.e. a monomer bearing at least two (meth)acrylate groups), such as bisphenol A di(meth)acrylate; hydrogenated bisphenol A di(meth)acrylate; ethylene glycol di(meth)acrylate; diethylene glycol di(meth)acrylate; triethylene glycol di(meth)acrylate; tetraethylene glycol di(meth)acrylate; polyethylene glycol di(meth)acrylate; propylene glycol di(meth)acrylate; dipropylene glycol di(meth)acrylate; tripropylene glycol di(meth)acrylate; tetrapropylene glycol di(meth)acrylate; polypropylene glycol di(meth)acrylate; polytetramethylene glycol di(meth)acrylate; 1,2-butanediol di(meth)acrylate; 2,3-butanediol di(meth)acrylate; 1,3-butanediol di(meth)acrylate; 1,4-butanediol di(meth)acrylate; 1,5-pentanediol di(meth)acrylate; 1,6-hexanediol di(meth)acrylate; 1,8-octanediol di(meth)acrylate; 1,9-nonanediol di(meth)acrylate; 1,10-nonanediol di(meth)acrylate; 1,12-dodecanediol di(meth)acrylate; neopentyl glycol di(meth)acrylate; 2-methyl-2,4-pentanediol di(meth)acrylate; polybutadiene di(meth)acrylate; cyclohexane-1,4-dimethanol di(meth)acrylate; tricyclodecane dimethanol di(meth)acrylate; metallic di(meth)acrylates; modified metallic di(meth)acrylates; glyceryl di(meth)acrylate; glyceryl tri(meth)acrylate; trimethylolethane tri(meth)acrylate; trimethylolethane di(meth)acrylate; trimethylolpropane tri(meth)acrylate; trimethylolpropane di(meth)acrylate; pentaerythritol di(meth)acrylate; pentaerythritol tri(meth)acrylate; pentaerythritol tetra(meth)acrylate, di(trimethylolpropane) diacrylate; di(trimethylolpropane) triacrylate; di(trimethylolpropane) tetraacrylate, sorbitol penta(meth)acrylate; di(pentaerythritol) tetraacrylate; di(pentaerythritol) pentaacrylate; di(pentaerythritol) hexa(meth)acrylate; tris (2-hydroxyethyl) isocyanurate tri(meth)acrylate; as well as the alkoxylated (e.g., ethoxylated and/or propoxylated) derivatives thereof; and combinations thereof.

The low viscosity reactive diluent may comprise a vinyl ether such as dodecyl vinyl ether, hydroxybutyl vinyl ether, cyclohexanedimethylol divinyl ether, and DVE-3 (triethylene glycol divinyl ether) and combinations thereof.

The low viscosity reactive diluent may comprise a vinyl amide such as N-vinylpyrrolidone (NVP), N-vinyl caprolactam (V-CAP) and combinations thereof.

The low viscosity reactive diluent may comprise a vinyl oxazolidinone such as vinyl methyl oxazolidinone (VMOX).

In a preferred embodiment the low viscosity reactive diluent preferably comprises a monofunctional (meth)acrylate or a mixture of a monofunctional (meth)acrylate and a polyfunctional (meth)acrylate.

In embodiments, the low viscosity reactive diluent may comprise a low viscosity (meth)acrylate monomer. For example, the low viscosity reactive diluent may comprise isodecyl acrylate, alkoxylated tetrahydrofurfuryl acrylate, di-trimethylolpropane tetraacrylate, octyl acrylate, isodecyl acrylate, decyl acrylate, PEG mono(meth)acrylates, isooctyl acrylate, caprolactone acrylate, tridecyl acrylate, alkoxylated neopentyl glycol diacrylate, alkoxylated lauryl acrylate, alkoxylated phenol acrylate, tridecyl methacrylate, lauryl acrylate, ethoxylated nonylphenol acrylate, ethoxylated phenol acrylate, glycerol methacrylate, isobornyl acrylate, isobornyl methacrylate, or combinations thereof.

The amount of low viscosity reactive diluent in the curable composition will vary depending on the desired viscosity. In embodiments, the curable composition may comprise, based on a weight of the curable composition, from 20% to 80% by weight of the low viscosity reactive diluent. In embodiments, the curable composition may comprise, based on a weight of the curable composition, equal to or greater than 20%, equal to or greater than 25%, equal to or greater than 30%, equal to or greater than 35%, or even equal to or greater than 40%, by weight of the low viscosity reactive diluent. In embodiments, the curable composition may comprise, based on a weight of the curable composition, equal to or less than 80%, equal to or less than 75%, equal to or less than 70%, equal to or less than 65%, or even equal to or less than 60%, by weight of the low viscosity reactive diluent. In embodiments, the amount by weight of the low viscosity reactive diluent in the curable composition, based on the total weight of the curable composition, may be from 20% to 80%, from 20% to 75%, from 20% to 70%, from 20% to 75%, from 20% to 60%, from 25% to 80%, from 20% to 75%, from 25% to 70%, from 25% to 75%, from 25% to 60%, from 30% to 80%, from 30% to 75%, from 30% to 70%, from 30% to 75%, from 30% to 60%, from 35% to 80%, from 35% to 75%, from 35% to 70%, from 35% to 75%, from 35% to 60%, from 40% to 80%, from 40% to 75%, from 40% to 70%, from 40% to 75%, or even from 40% to 60%, or any and all subranges formed from any of these endpoints.

In a preferred embodiment, the curable composition may comprise at least 6%, at least 10%, or at least 15% by weight of a polyfunctional (meth)acrylate monomer as defined above, based on the total weight of the curable composition. Alternatively, the curable composition, may comprise less than 6%, less than 5%, less than 4%, less than 3%, less than 2%, less than 1% or even 0% by weight of a polyfunctional (meth)acrylate monomer as defined above, based on the total weight of the curable composition.

In embodiments, a weight ratio of the oligomer to the low viscosity reactive diluent in the curable composition may be from 4:1 to 1:4, such as from 3:1 to 1:4, from 2:1 to 1:4, from 1:1 to 1:4, from 3:1 to 1:3, from 2:1 to 1:3, from 1:1 to 1:3, from 3:1 to 1:2, from 2:1 to 1:2, from 1:1 to 1:2, from 3:1 to 1:1, or even from 2:1 to 1:1, or any and all subranges formed from any of these endpoints.

### Curable Composition

In embodiments, the curable compositions may have a glass transition temperature T_{g} of about 20° C. or less when cured or about 10° C. or less when cured. In embodiments, the curable compositions may be liquid at a temperature of 25° C.±2° C. In embodiments, the curable composition may have a viscosity, as measured by Brookfield DV-III viscometer using Spindle SC-27 at 60° C., of equal to or less than 50,000 cP, such as equal to or less than 45,000 cP, equal to or less than 40,000 cP, equal to or equal than 35,000 cP, equal to or less than 30,000 cP, equal to or less than 25,000 cP, equal to or less than 20,000 cP, 15,000 cP or less, 12,500 cP or less, or even 10,000 cP or less. Such viscosity features facilitate spreading of the composition on a substrate for film formation.

In a preferred embodiment, the curable composition may have a viscosity, as measured by Brookfield DV-III viscometer using Spindle SC-27 at 25° C., of equal to or less than 50,000 cP, such as equal to or less than 45,000 cP, equal to or less than 40,000 cP, equal to or equal than 35,000 cP, equal to or less than 30,000 cP, equal to or less than 25,000 cP, equal to or less than 20,000 cP, 15,000 cP or less, 12,500 cP or less, or even 10,000 cP or less.

In embodiments, the curable compositions may comprise less than 1 wt % of solvent and less than 1 wt % of water or are free of solvent and are free of water. In embodiments, a film or coating may be formed by curing the curable composition.

### Method of Preparing and Curing the Curable Composition

The invention also relates to a method of preparing the curable composition according to the invention. The method of preparing the curable composition comprises the following steps:
preparing an oligomer according to the invention dissolved in a non-reactive solvent;
adding the low viscosity reactive diluent to obtain a diluted curable composition;
removing at least part of the non-reactive solvent from the diluted curable composition to obtain the curable composition according to the invention.

The oligomer dissolved in a non-reactive solvent may be prepared by solution polymerization as described above. The oligomer, the non-reactive solvent and the reactive diluent may be as defined above. The non-reactive solvent may be at least partly removed by heating the diluted curable composition, for example at a temperature of 40° C. or more, in particular 50° C. or more, more particularly 60° C. or more. The amount of non-reactive solvent after the removal step may be less than 1%, less than 0.5%, or even 0%, by weight of non-reactive solvent based on the weight of the curable composition.

The invention also relates to a method of curing the curable composition according to the invention. The method of curing the curable composition comprises curing the curable composition.

The curing step may be carried out at ambient temperature (i.e. 10-30° C.).

The curing step may be carried out by irradiating the composition with a light source having a wavelength and/or an intensity that is able to activate the polymerized chromophore monomer units of the oligomer of the invention and cause crosslinking of said oligomer and/or said reactive diluent. The curing step may be carried out in the absence of a photoinitiator other than the oligomer of the invention. In other words, the curable composition may comprise less than 0.1%, in particular less than 0.05%, more particularly less than 0.001%, even more particularly 0% by weight of photoinitiator other than the oligomer of the present invention, based on the weight of the curable composition.

The method of curing the curable composition of the invention may not involve a pre-curing step, in particular a step of curing at least part of the low viscosity reactive diluent prior to crosslinking the oligomer of the invention, for example by irradiating the curable composition with a light source having a long wavelength and/or a low intensity in the presence of a photoinitiator other than the oligomer of the present invention. As used herein, a light source having a long wavelength and/or a low intensity is a light source that is not able to activate the polymerized chromophore monomer units of the oligomer of the invention and cause crosslinking of said oligomer and/or said reactive diluent. An example of a light source having a long wavelength and/or a low intensity is a blacklight (as opposed to a mercury vapor lamp which is able to activate chromophores comprising a benzophenone moiety or a LED-UV lamp which is able to activate chromophores comprising a thioxanthone moiety). Preferably, the method of curing the curable composition of the invention comprises a curing step in which at least part of the low viscosity reactive diluent and at least part of the oligomer of the invention are simultaneously cured. Without being bound by theory, such a curing method is believed to enable the grafting of at least part of the low viscosity reactive diluent on at least part of the oligomer of the invention.

### Method of Coating a Substrate

The invention also relates to a method of coating a substrate.

In embodiments, methods of coating substrates may comprise applying the curable composition to a substrate and curing the curable composition. Preferably, the step of applying the curable composition is carried out at/at ambient temperature (i.e. 10-30° C.). In other words, the curable composition does not need to be heated prior to being applied on a substrate. In embodiments, the substrate may be a high surface energy substrate, such as a metal or a low surface energy substrate, such as plastic. The substrate may be any commercially relevant substrate, such as a high surface energy substrate or a low surface energy substrate, such as a metal substrate or plastic substrate, respectively. The substrates may comprise stainless steel, paper, cardboard, glass, polyolefins, PET, PVC, PMMA, PC, composites and wood.

In embodiments, the curable composition may be applied to a substrate by spraying, knife coating, roller coating, casting, drum coating, dipping, and the like, and combinations thereof. The curing may be carried out as described above for the method of curing the curable composition of the invention. In embodiments, the curing may comprise curing by exposure to one of the group consisting of visible radiation, UV radiation, LED radiation, laser radiation, electron-beam radiation, peroxide, accelerator and heat. In embodiments, the curing comprises combinations of these curing techniques. More particularly, the curable composition may be fully cured by exposing the composition to ultraviolet (UV) radiation. The ultraviolet curable composition may advantageously be cured by exposing the composition to a LED light source.

### Adhesive

In embodiments, a pressure sensitive adhesive may be made or prepared from the curable compositions described herein. In embodiments, a cured product may be made or prepared from the curable compositions described herein. In embodiments, use may be made of the curable compositions described herein in adhesives, particularly pressure sensitive adhesives.

Embodiments of the curable compositions described herein may find use as an adhesive tape, an adhesive sheet, an adhesive spray, a product package, a product label, a construction article or a medical product and more particularly said pressure sensitive adhesive is for packaging, labelling, construction, model making, medicine and construction applications.

### Additives

In embodiments, the curable composition may further comprise 0.1 wt % to 40 wt % of at least one tackifying resin. In embodiments, the at least one tackifying resin may have a softening temperature of 20° C. or less. In embodiments, the at least one tackifying resin may be selected from the group consisting of piperylene-based hydrocarbon resins which may be hydrogenated and hydrogenated or non-hydrogenated rosin esters, modified by maleic anhydride rosin esters.

The PSA systems may also optionally comprise other additives, such as an additive selected from the group consisting of, wetting agents, adhesion promoters, fillers, rheology modifiers, thixotropic agents, plasticizers, UV absorbers, UV stabilizing agents, dispersants, antioxidants, antistatic agents, lubricants, opacifying agents, anti-foam agents, rheology agents, and the like, and combinations thereof.

In a preferred embodiment, the curable composition may be substantially free of a photoinitiator other than the oligomer of the present invention. In particular, the curable composition may comprise less than 0.1%, in particular less than 0.05%, more particularly less than 0.001%, even more particularly 0% by weight of photoinitiator other than the oligomer of the present invention.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Material

The following materials were used in the examples:

TABLE 1

| Abbreviation | Chemical name | Supplier |
|---|---|---|
| BENZO | 4-acryloyloxy benzophenone | Sigma Aldrich Chemical Company |
| MEK | methyl ethyl ketone | Sigma Aldrich Chemical Company |
| BA | butyl acrylate | Sigma Aldrich Chemical Company |
| MMA | methyl (meth)acrylate | Sigma Aldrich Chemical Company |
| TBA | Tert-butyl acrylate | Sigma Aldrich Chemical Company |
| DMAEA | dimethylaminoethyl acrylate | Sigma Aldrich Chemical Company |
| DMAEMA | dimethylaminoethylmethacrylate | Sigma Aldrich Chemical Company |
| DEAEA | diethylaminoethyl acrylate | Sigma Aldrich Chemical Company |
| ACMO | acryloylmorpholine | Sigma Aldrich Chemical Company |
| NVP | n-vinyl-2-pyrrolidone | Sigma Aldrich Chemical Company |
| AA | acrylic acid | Sigma Aldrich Chemical Company |
| HEEUMA | hydroxyethyl ethylene urea methacrylate | Sigma Aldrich Chemical Company |
| SR395 | isodecyl acrylate | Sartomer |
| SR611 | alkoxylated tetrahydrofurfuryl acrylate | Sartomer |
| SR355 | ditrimethylolpropane tetraacrylate | Sartomer |
| CN146 | acrylic oligomer | Sartomer |
| CN147 | acidic acrylate oligomer | Sartomer |
| Vazo 52 | 2,2′-azobis(2-methylbutyronitrile | Sigma Aldrich Chemical Company |

### Methods

### Molecular Weight

The number average molecular weight (Mn) and weight average molecular weight (Mw) of the oligomers were determined using a size exclusion chromatography (SEC) using poly(methyl methacrylate) reference standards and tetrahydrofuran as the solvent with the following conditions:
Column s: Agilent pLgel 5 micron 100A, 250×4.6 mm; Agilent pLgel 3 micron MiniMix E, 250×4.6 mm; Agilent pLgel 5 micron MiniMix D, 250×4.6 mm,
Detector: refractive index detector.
Flow rate of solvent: 0.45 μL/min
Temperature: 40° C.
Volume of sample injection: 25 μL.

### Example 1: Curable Compositions Comprising an Oligomer Having Polymerized Benzophenone Units

Tables 2 and 3 below show the components (in weight percent) used to form the oligomer and certain properties of Comparative Examples C1 to C6 and Examples E1 to E26.

The oligomers were obtained by solution polymerization of the monomers indicated in Tables 2 and 3 using an amount of MEK as solvent as indicated in Tables 2 and 3. The solvent and monomers were added to a 60 mL vial. A Vazo 52 initiator solution in the solvent was prepared in a separate vial, then added to the monomer solution (total monomer:initiator weight ratio of 400:1). The vial was then put into a water bath at 65° C. and lightly shaken for 11 hours. The type of solvent, solids content, reaction temperature, reaction time and initiator:monomer ratio can be adjusted to produce oligomers of various molecular weights using experimental conditions well known by those skilled in the art. Monomer:Vazo 52 ratios between 100:1 and 1000:1 were typically used to produce oligomers of relatively low molecular weights as described and used in the following examples.

Formulations for evaluating the cure speed according to Method B below were made by adding the components listed in Tables 2 and 3 to SR355 in a Flacktek® polypropylene cup and mixed until homogenous at 1500 rpm for two damants using a Flacktek® DAC 400.2 VAC high-speed mixer.

Formulations for evaluating the peel strength of UV-curable pressure sensitive adhesives (UV-PSAs) according to Method C below were made by adding the components listed in Tables 2 and 3 to a 1:1 ratio of SR395/SR611 such that the final concentration of the oligomer to SR395/SR611 was 2:1:1 after MEK evaporation. The formulations were added to a Flacktek® polypropylene cup and mixed until homogenous at 1500 rpm for two minutes using a Flacktek® DAC 400.2 VAC high-speed mixer.

TABLE 2

| | | | | | Weight |
|---|---|---|---|---|---|
| | | | Final | | average |
| | | | MEK | Predicted T_{g} | molecular |
| Example | Backbone (wt %) | | (wt %) | (° C.) | weight (M_{w}) |
| E1 | BA | 95 | 37.9 | −48 | 32522 |
| | MMA | 4 | | | |
| | BENZO | 1 | | | |
| E2 | BA | 80 | 42.5 | −26 | 23856 |
| | MMA | 15 | | | |
| | BENZO | 5 | | | |
| C1 | MMA | 99 | 32.8 | 109 | 14181 |
| | BENZO | 1 | | | |
| E3 | BA | 80 | 40.7 | −31 | 25162 |
| | TBA | 15 | | | |
| | BENZO | 5 | | | |
| E4 | BA | 95 | 53.4 | −49 | 21960 |
| | TBA | 4 | | | |
| | BENZO | 1 | | | |
| E5 | BA | 91.16 | 44.0 | −38 | 24958 |
| | MMA | 3.84 | | | |
| | BENZO | 5 | | | |
| C2 | BA | 54.5 | 50.0 | 0 | 19636 |
| | MMA | 44.5 | | | |
| | BENZO | 1 | | | |
| C3 | BA | 38.5 | 49.4 | 25 | 19092 |
| | MMA | 60.5 | | | |
| | BENZO | 1 | | | |
| C4 | BA | 25 | 50.1 | 50 | 16620 |
| | MMA | 74 | | | |
| | BENZO | 1 | | | |
| E6 | BA | 69.5 | 32.5 | −20 | 26563 |
| | MMA | 26.5 | | | |
| | BENZO | 1 | | | |
| E7 | BA | 62.5 | 50.0 | −13 | 33063 |
| | MMA | 36.5 | | | |
| | BENZO | 1 | | | |
| E8 | BA | 92.12 | 31.7 | −46 | 19131 |
| | MMA | 3.88 | | | |
| | BENZO | 1 | | | |
| | DMAEA | 3 | | | |
| E9 | BA | 92.12 | 29.0 | −46 | 16266 |
| | MMA | 3.88 | | | |
| | BENZO | 1 | | | |
| | DEAEA | 3 | | | |
| E10 | BA | 92.12 | 31.2 | −45 | 119308 |
| | MMA | 3.88 | | | |
| | BENZO | 1 | | | |
| | ACMO | 3 | | | |
| E11 | BA | 92.12 | 20.4 | −45 | 29053 |
| | MMA | 3.88 | | | |
| | BENZO | 1 | | | |
| | ACMO | 3 | | | |
| E12 | BA | 92.12 | 29.7 | −46 | 81787 |
| | MMA | 3.88 | | | |
| | BENZO | 1 | | | |
| | NVP | 3 | | | |
| E13 | BA | 92.12 | 36.0 | −46 | 21408 |
| | MMA | 3.88 | | | |
| | BENZO | 1 | | | |
| | DMAEMA | 3 | | | |

TABLE 3

| Example | Backbone (wt %) | | Number average molecular weight (Mₙ) |
|---|---|---|---|
| E1 | BA | 95 | 11629 |
| | MMA | 4 | |
| | BENZO | 1 | |
| E14 | BA | 95 | 32489 |
| | MMA | 4 | |
| | BENZO | 1 | |
| E15 | BA | 90 | 13657 |
| | MMA | 4 | |
| | BENZO | 1 | |
| | AA | 5 | |
| E16 | BA | 90 | 32102 |
| | MMA | 4 | |
| | BENZO | 1 | |
| | AA | 5 | |
| E17 | BA | 90 | 14988 |
| | MMA | 4 | |
| | BENZO | 1 | |
| | CN146 | 5 | |
| E18 | BA | 90 | 30908 |
| | MMA | 4 | |
| | BENZO | 1 | |
| | CN146 | 5 | |
| E19 | BA | 95 | 10212 |
| | MMA | 2 | |
| | BENZO | 1 | |
| | HEEUMA | 2 | |
| E20 | BA | 95 | 23802 |
| | MMA | 2 | |
| | BENZO | 1 | |
| | HEEUMA | 2 | |
| E21 | BA | 92.5 | 12613 |
| | MMA | 4 | |
| | BENZO | 1 | |
| | AA | 2.5 | |
| E22 | BA | 92.5 | 47327 |
| | MMA | 4 | |
| | BENZO | 1 | |
| | AA | 2.5 | |
| C5 | BA | 94 | 10010 |
| | BENZO | 1 | |
| | AA | 5 | |
| C6 | BA | 94 | 28922 |
| | BENZO | 1 | |
| | AA | 5 | |
| E23 | BA | 90 | 17353 |
| | MMA | 4 | |
| | BENZO | 1 | |
| | CN147 | 5 | |
| E24 | BA | 90 | 37271 |
| | MMA | 4 | |
| | BENZO | 1 | |
| | CN147 | 5 | |
| E25 | BA | 97 | 10955 |
| | MMA | 1 | |
| | BENZO | 1 | |
| | HEEUMA | 1 | |
| E26 | BA | 97 | 32390 |
| | MMA | 1 | |
| | BENZO | 1 | |
| | HEEUMA | 1 | |

The following methods were used to analyze the oligomers in the application:

### Method A—Gel Content

The gel content of the neat oligomers were measured by curing a 3 MIL wet coating using an H bulb (small Fusion LC6, 15 fpm, three passes). The draw-down thickness depended on the final MEK percentage in the oligomer. For instance, if the examples were provided as either 60% monomers and 40% MEK, or 50% monomers and 50% MEK, thenle examples having 40% MEK were drawn down from 5 MIL thick and the examples having 50% MEK were drawn down from 6 MIL thick such that after evaporation of MEK, the film thickness is 3 MIL. After the draw-down, the glass slides were placed in a 60° C. oven for 1 hour to remove the solvent. The samples were cured in air or nitrogen. The samples were removed from the glass slides after curing and placed in a solution of MEK for 24 hours. Gel content was given as a percentage of the remaining weight of the sample after 24 hours of soaking in MEK as compared to the initial weight of the sample as given by the equation below.

$$Gel content ( \% ) = \frac{final weight}{initial weight} * 100$$

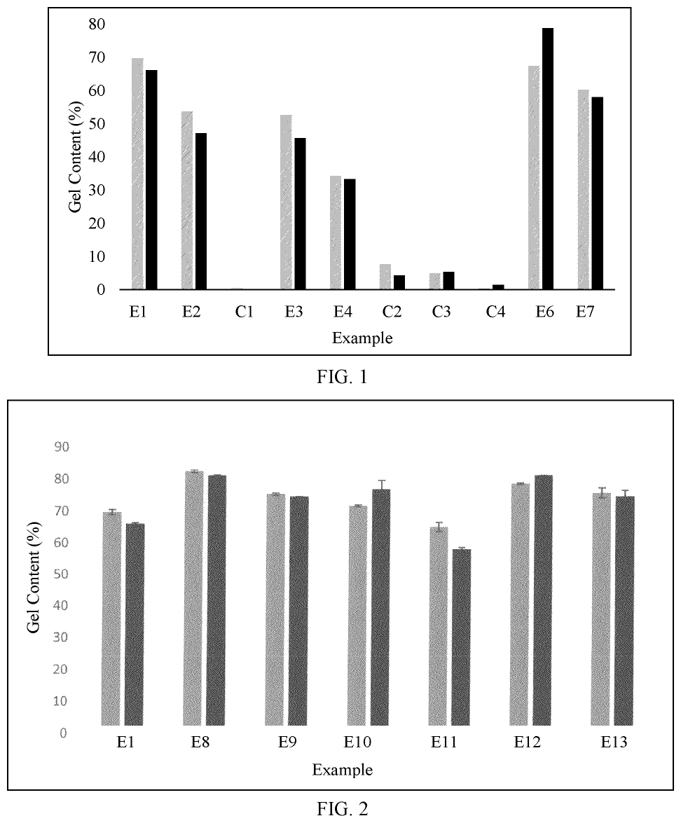

Referring now to FIG. 1, environment (i.e., air (shown in gray bars) or nitrogen (shown in black bars) had minimal effect on gel content. Example E6, an oligomer including 69.5 wt % BA, 26.5 wt % MMA, and 1 wt % BENZO, had a gel content of 67 wt % (air) and 79% (nitrogen). On the other hand, Comparative Example C2, an oligomer including 54.5 wt % BA, 44.5 wt % MMA, and 1 wt % BENZO, had a gel content of less than 5 wt % when cured in air and nitrogen. As exemplified by FIG. 1, gel content decreases as MMA, a high T_{g} monomer unit, increases. Accordingly, the amount of polymerized high T_{g} monomer units and polymerized low T_{g} monomer units in the oligomer may be tailored to achieve a desired crosslinking amount, as indicated gel content.

Referring now to FIG. 2, the gel content of Examples E8-E13, oligomers including additional (synergist) monomer units, were comparable to Example E1, an oligomer not including additional (synergist) monomer units. While not wishing to be bound on theory, the additional (synergist) monomer units may not have as significant impact on gel content because the BENZO attached to the oligomer backbone was enough chromophore to fully crosslink the system, regardless of the additional (synergist) monomer units being present. Note that examples cured in air are shown in light gray bars and examples cured in nitrogen are shown in dark gray bars.

Referring now to FIG. 3, gel content was measured on different M_{w} versions of Example E1 with different BENZO loadings on the oligomer back bone and in different environments (i.e., from left to right for each BENZO loading: 10 k MW Air (light gray bar); 10 k MW Nitrogen (dark gray bar); 26 k MW Air (medium gray bar); 26 k MW Nitrogen (black bar)). Gel content was higher for the higher M_{w} versions of each oligomer. Gel content steadily decreased as the amount of BENZO decreased, indicated that less chromophore is available to crosslink the system leading to a less crosslinked gel. As exemplified by FIG. 3, sufficient gel content (e.g., greater than 50%) may be achieved even when the BENZO amount is decreased to 0.5 wt %.

### Metho-B—Photo Differential Scanning Calorimetry (PhotoDSC)

Examples were combined with SR355 in an initial weight ratio of oligomer:SR355 and were placed in a Tzero pan and residual solvent was flashed off in the oven. The initial weight ratio of the oligomer:SR355 was selected to achieve a 1:1 weight ratio of oligomer:SR355 after the solvent was flashed off. The samples were exposed to a broad spectrum UV light (100 mW/cm²) for two minutes.

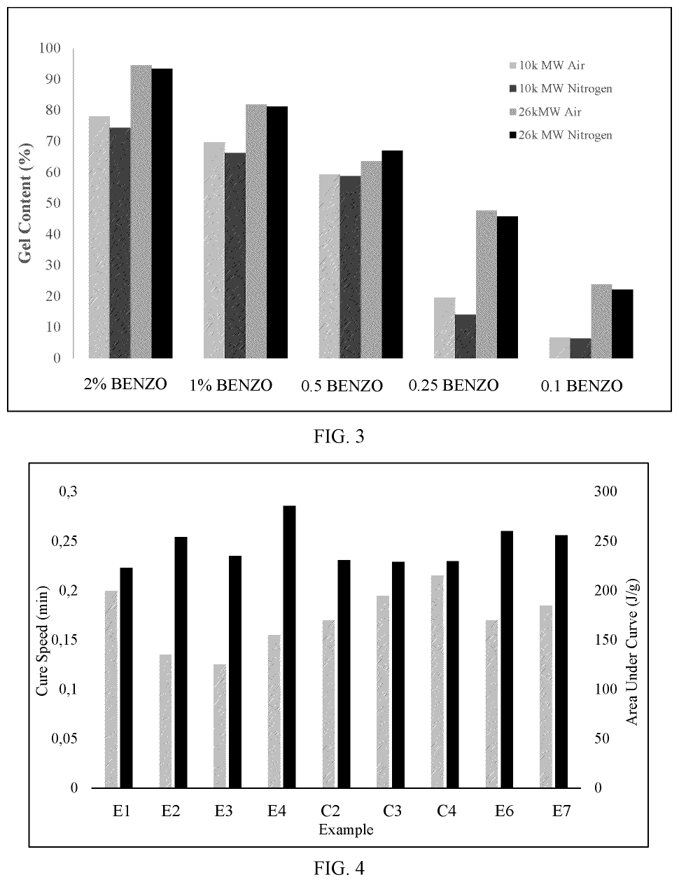

Referring now to FIG. 4, the cure speeds (i.e., time it took to reach peak maximum) of the examples indicated were recorded (shown by gray bars in FIG. 4). The heat flow area under each curve was measured along with the maximum temperature achieved during cure (shown in black bars in FIG. 4). As exemplified by FIG. 4, the cure speed increased as the amount of MMA increased. Accordingly, the amount of polymerized high T_{g} monomer units and polymerized low T_{g} monomer units in the oligomer may be tailored to achieve a desired cure speed. Moreover, all of Comparative Examples C2-C4 and Examples E1-E4, E6, and E7 induced crosslinking with SR355. However, Comparative Examples C2-C4 did not induce crosslinking with itself.

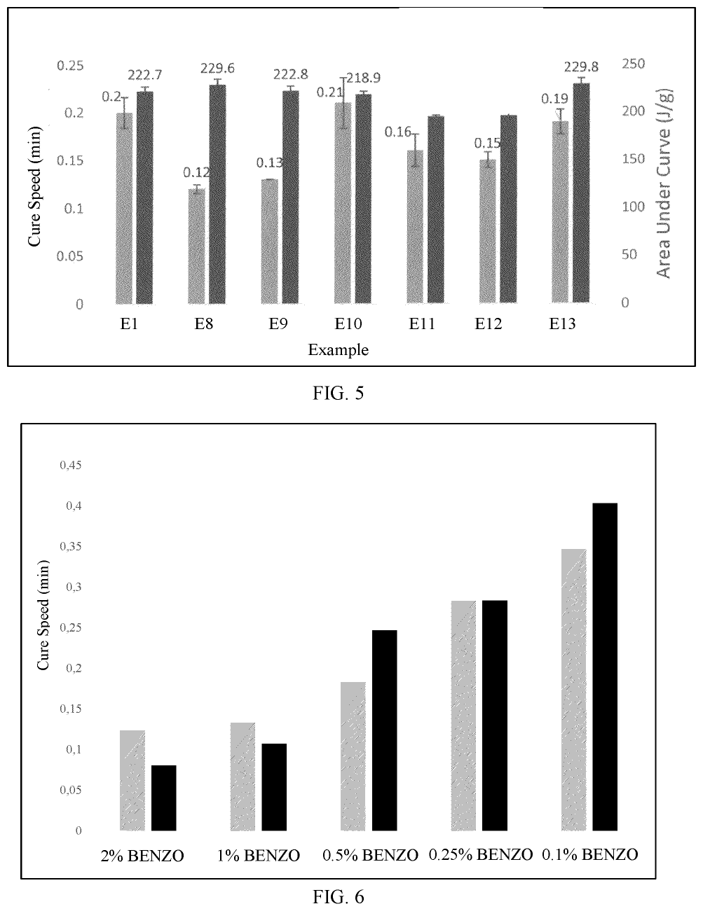

Referring now to FIG. 5, cures speeds of the indicated examples were recorded (shown by light gray bards in FIG. 5). The heat flow area under each curve was measured along with the maximum temperature achieved during cure (shown in dark gray bars in FIG. 5). Examples E8-E13, oligomers including additional (synergist) monomer units, had faster cures speeds than Example E1, an oligomer not including additional (synergist) monomer units. As exemplified in FIG. 10, incorporating additional synergist monomer units in the oligomer increases cure speed.

Referring now to FIG. 6, cure speeds were recorded for 10 k Mw versions of Example E1 (shown in gray bars) and 26 k versions of Example E1 (shown in black bars) with different amounts of BENZO. As the amount of BENZO decreased, the cure speed decreased. As exemplified by FIG. 11, the amount of BENZO in the oligomer may be tailored to achieve a desired cure speed.

### Method C—Peel Strength of UV Curable Pressure Sensitive Adhesives (UV-PSA)

A 50 μm two-tape guide was used to draw down the examples and achieve a uniform film thickness. After drawn down, the films were placed in a 60° C. oven for one hour to allow the MEK solvent to be removed from the films. After drying, the films were subjected to Fusion H bulb curing at 15 fpm, three passes to crosslink the oligomer and form the UV-PSA. One inch strips were cut and the UV-PSA was laminated on to a stainless streel substrate. The UV-PSAs were allowed to age in a constant temperature room for 24 hours before testing. The 180° peel strength was measured in accordant with ASTM D3330 at 12 in/min using an Instron.

During 180° peel testing, the examples failed adhesively rather than cohesively. This means that the resulting peal strength was a measure of the examples being fully removed from the stainless streel substrate (adhesive failure) versus resulting from a chemical bond failure within the example (cohesive failure)

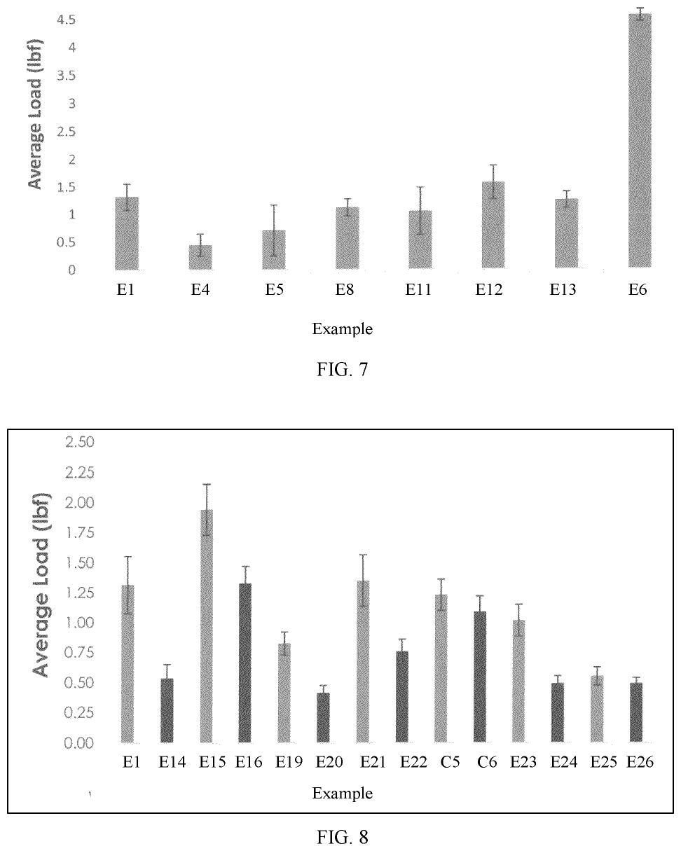

Referring now to FIG. 7, Examples E8-E13, oligomers including additional (synergist) monomer units, had similar peel strengths as Example E1, an oligomer not including additional (synergist) monomer units. As exemplified by FIG. 12, additional (synergist) monomer units may be included in the oligomer and not have a significant effect on peel strength. Regarding E9, while not wishing to be bound by theory, the relatively high peel strength was due to over crosslinking of the oligomer.

Referring now to FIG. 8, Examples, E15, E16, and E21, oligomers including acrylic acid, had a higher peel strength as compared to Example E1, an oligomer not including acrylic acid. As exemplified by FIG. 13, acrylic acid may be included in the oligomer to improve the peel strength thereof.

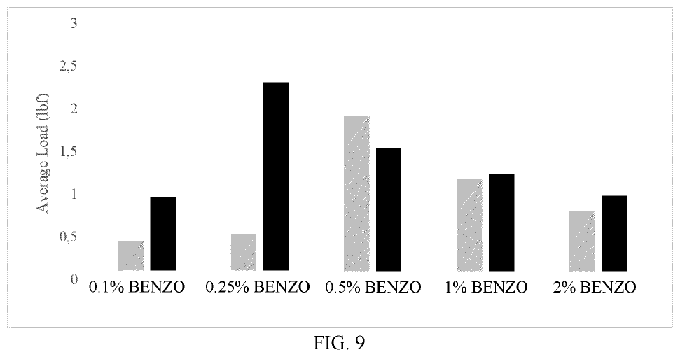

Referring now to FIG. 9, the peel strength was measured for 10 k Mw versions of Example E1 (shown in gray bars) and 26 k versions of Example E1 (shown in black bars) with different amounts of BENZO. As shown, by decreasing the amount of BENZO to 0.25 wt % or 0.5 wt %, there was an increase in the peel strength. While not wishing to be bound by theory, the 1 wt % and 2 wt % BENZO examples had a lower peel strength due to the oligomer being over-crosslinked. Peel strength decreased significantly at BENZO amount less than or equal to 0.25 wt %. Note that the example with 0.25 wt % BENZO had a peel strength of 0.5 lbF at 10 k M_{w}, but greater than 2 lbF at 26 k M_{w}. This was due to the gel content at 10 k Mw being less than 20%, while at 26 k M_{w} it was about 50% for the examples with 0.25% BENZO. As exemplified by FIG. 14, the M_{w} of the oligomer had an effect on the peel strength of the oligomers with less than 0.5 wt % BENZO. However, a greater effect was seen with differences in BENZO amount.

### Example 2: Oligomer Having Polymerized Thioxanthone Units

Oligomers composed of butyl acrylate, acrylic acid and an acrylated thioxanthone in a weight ratio of 94.9/5/0.1 were synthesized using the general solution polymerization process described in Example 1 using 50% by weight of ethyl acetate as solvent. The acrylated thioxanthones were TX1 or TX2 having the structures as shown below.

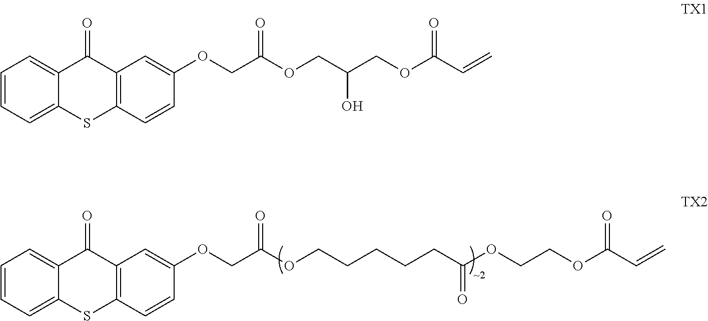

The solutions of the oligomers in ethyl acetate were coated on 50 micron PET backing and solvent was removed at 60° C. for 1 hour to produce ca. 56-80 micron thick PSA films. The dried films were UV cured using a Phoseon 8 W 395 nm LED curing unit using 3 passes at 50 fpm linespeed. The backed PSA was tested at room temperature (20-25° C.) for 180 degree peel strength per methods described in ASTM D3330 and shear strength per methods described in ASTM D3654. The peel and shear failure modes were both cohesive. Data is summarized in the Table below:

| | | | | 25° C. static |
|---|---|---|---|---|
| | | | 180 peel | shear |
| | Mn | Tg | strength | strength |
| Oligomer | (g/mol) | (° C.) | (#/inch width) | (hours) |
| BA/AA/TX1: 94.9/5/0.1 | 19,789 | −47.2 | 15.6 | 1.4 |
| BA/AA/TX2: 94.9/5/0.1 | 27,405 | −47.2 | 8.6 | 7.3 |

The data shows that oligomers with pendant thioxanthone groups can be used as UV curable pressure sensitive adhesive base resins. The oligomers can be combined with SR355 in a 1:1 weight ratio to obtain a curable composition according to the invention.

### Example 3: Oligomer Having Polymerized Thioxanthone Units

An oligomer composed of butyl acrylate, acrylic acid and acrylated thioxanthone TX2 in a weight ratio of 94.9/5/0.1 was synthesized using the general solution polymerization process described in Example 1 in 60% wt of toluene. The acrylated thioxanthone TX2 has the structure as shown in Example 2. The oligomer exhibits a Mₙ value of 27,557 g/mol, a M_{w} of 154,918 g/mol and a T_{g} of XXXX° C.

PET film backing 0.05 mm thick was cut from a roll to a 152 mm×305 mm piece and taped at one end to a 152 mm×305 mm×0.63 mm aluminum panel. The aluminum panel-backed PET film was secured to an Automatic Film Applicator-MSK-AFA-II manufactured by MTI Corporation (Richmond, CA). The solution of the oligomer in Toluene was coated on the PET film via drawdown method using a 0.25 mm bar film applicator. The prepared coating with its PET backing and aluminum panel support, was dried in a laboratory hood for 30 minutes and further dried in a 60° C. oven. Subsequently, the coating was exposed to H-bulb UV energy from a Fusion conveyor system at a belt speed of 16 feet/minutes. The sample coating was passed through 4 times and ultimately receiving the energy shown in the Table below:

| | mJ/m² | mW/cm² |
|---|---|---|
| H-bulb UVA | 2248 | 6248 |
| H-bulb UVB | 2584 | 7332 |
| H-bulb UVC | 620 | 1760 |
| H-bulb UVV | 2996 | 8180 |

A release film was placed over the coated PET film as a temporary protective layer and 25 mm (1 inch) strips were made using a paper cutter. The coating thickness was determined using vernier calipers and measured 0.038 (+/−0.012) mm. Each 25 mm wide strip (tape) was applied to a 50 mm×125 mm stainless-steel panel (from ChemInstruments). The coated 25 mm tape sample was adhered lengthwise to the steel panel using a mechanical 2 Kg ChemInstruments roller to ensure constant and reproducible pressure during application. The assembled samples were conditioned for 24 hours at 25° C./50% relative humidity.

The following methods were used to analyze the oligomer.

### 180°—Peel and Static Shear Strength Testing Methods

An Instron model #5433 physical tester with pneumatic rubber padded grips fitted with a X-kN load cell was used for 180°-peel strength testing. Testing was based on ASTM D3330. The crosshead speed was set a 0.5 cm/minute at ambient lab conditions. Bond strength values were measured and reported in pound-force per inch (lbf/in). The Coefficient Value (CV) and Standard Deviation (SD) were also reported.

Shear samples were drawn down in a similar manner as described above, exposed to H-bulb UV energy, cut into 25 mm (1 inch) strips, and adhered to 51 mm×76 mm stainless steel panels. The samples were tested according to ASTM D3654 using 1 Kg weights at ambient laboratory conditions (20-25° C.).

180°-Peel data for H-bulb (only) and failure mode:

| Sample | Average lbf/in | CV % | SD | Failure Mode |
|---|---|---|---|---|
| BA 94.5/AA | 2.65 | 11.84 | 0.31369 | Adhesive |
| 5.0/PRO22791 0.5 | | | | |
| H-bulb | | | | |

Static shear data for H-bulb (only)

| | | | Film | | |
|---|---|---|---|---|---|
| | Cure | | Thickness, | Mass, | |
| Sample | Method | Hours | mm | g | Comments |
| BA 94.5/AA | H-bulb | 6.8 | 0.045-0.051 | 1000 | Cohesive |
| 5.0/PRO22791 0.5 | | | | | failure |

The data shows that a, oligomer with pendant thioxanthone groups can be used as UV curable pressure sensitive adhesive base resin. The oligomer can be combined with SR355 in a 1:1 weight ratio to obtain a curable composition according to the invention.

### ASPECTS

Further aspects of the invention are provided by the subject matter of the following clauses:

Clause 1. A curable composition comprising: an oligomer comprising, based on the total weight of the oligomer: from 1% to 80% by weight polymerized high T_{g} monomer units, the high T_{g} monomer units being chosen from (meth)acrylate monomers having a glass transition temperature (T_{g}) greater than 25° C.; from 10% to 98.9% by weight polymerized low T_{g} monomer units, the low T_{g} monomer units being chosen from monovalent (meth)acrylate monomers having a T_{g} equal to or less than 25° C.; from 0.1% to 40% by weight polymerized chromophore monomer units, the chromophore monomer units being chosen from (meth)acrylate monomers having a pendent Norrish Type II chromophore; and from 0% to 20% by weight at least one polymerized additional monomer unit; and a low viscosity reactive diluent having a viscosity equal to or less than 3000 cP at 25° C., wherein: the oligomer has a weight average molecular weight of at least 10,000 grams per mole (g/mol); the oligomer has a T_{g} equal to or less than −10° C.; and the curable composition has a viscosity of equal to or less than 50,000 cP at 60° C., preferably equal to or less than 50,000 cP at 25° C.

Clause 2. The curable composition of any preceding clause, wherein a weight ratio of the oligomer to the low viscosity reactive diluent is from 4:1 to 1:4.

Clause 3. The curable composition of any preceding clause, wherein the curable composition comprises, based on the weight of the curable composition: from 20% to 80% by weight of the oligomer; and from 20% to 80% by weight of the low viscosity reactive diluent.

Clause 4. The curable composition of any preceding clause, wherein the oligomer comprises, based on the total weight of the oligomer:
from 1% to 50%, in particular from 3% to 44% by weight of the polymerized high T_{g} monomer units;
from 50% to 97%, in particular from 55% to 95% by weight of the polymerized low T_{g} monomer units;
from 0.1% to 10%, in particular from 0.1% to 2% by weight of the polymerized chromophore monomer units
from 0 to 5% by weight of the polymerized additional monomer units.

Clause 5. The curable composition of any preceding clause, wherein the oligomer has a weight average molecular weight from 10,000 g/mol to 600,000 g/mol, in particular from 10,000 g/mol to 100,000 g/mol, more particularly from 10,000 g/mol to 50,000 g/mol, even more particularly from 11,000 g/mol to 49,000 g/mol, more particularly still from 12,000 g/mol to 48,000 g/mol, yet more particularly from 15,000 g/mol to 45,000 g/mol, yet even more particularly still from 15,000 g/mol to 40,000 g/mol.

Clause 6. The curable composition of any preceding clause, wherein a weight ratio of low T_{g} monomer units to high T_{g} monomer units in the oligomer is from 24:1 to 1.5:1.

Clause 7. The curable composition of any preceding clause, wherein the T_{g} of the high T_{g} monomer units is at least 20° C. greater than the T_{g} of the low T_{g} monomer units.

Clause 8. The curable composition of any preceding clause, wherein each of the high T_{g} monomer units may be according to formula (I):

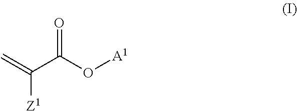

where: A¹ is H, (C₁-C₃₀)hydrocarbyl or (C₁-C₃₀)heterohydrocarbyl, preferably H or (C₁-C₃₀)hydrocarbyl; and Z¹ is —H or —CH₃.

Clause 9. The curable composition of any preceding clause, wherein the high T_{g} monomer units of the oligomer are chosen from (meth)acrylic acid, 2-phenylethyl methacrylate, 3,3,5-trimethylcyclohexyl acrylate, tert-butyl acrylate, octadecyl methacrylate, octadecyl acrylate, propyl methacrylate, benzyl methacrylate, isobutyl methacrylate, ethyl methacrylate, 2,2,3,3-tetrafluoropropyl methacrylate, 2,2,2-trifluoroethyl methacrylate, isopropyl methacrylate, isobornyl acrylate, methyl methacrylate, isobornyl methacrylate, phenyl methacrylate, tert-butyl methacrylate, cyclohexyl methacrylate, 4-tert-butylcyclohexyl acrylate, 4-tert-butylcyclohexyl methacrylate, 3,3,5-trimethylcyclohexyl acrylate, 3,3,5-trimethylcyclohexyl methacrylate, a substituted or unsubstituted (C₆-C₁₂)cycloalkyl (meth)acryla damantlyntyl (meth)acrylate, tricyclodecane methanol mono(meth)acrylate, or combinations thereof damantly.

Clause 10. The cruable composition of any preceding clause, wherein the high T_{g} monomer units of the oligomer are chosen from methyl methacrylate, tert-butyl (meth)acrylate, (meth)acrylic acid, isobornyl (meth)acrylate or combinations thereof.

Clause 11. The curable composition of any preceding clause, wherein each of the low T_{g} monomer units may be according to formula (II):

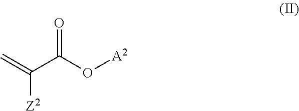

where: A² is (C₂-C₃₀)hydrocarbyl or (C₂-C₃₀)heterohydrocarbyl, preferably (C₄-C₃₀)hydrocarbyl; and Z² is —H or —CH₃.

Clause 12. The curable composition of any preceding clause, wherein the low T_{g} monomer units of the oligomer are chosen from n-butyl (meth)acrylate, isobutyl acrylate, hexyl (meth)acrylate, 2-ethylhexyl (meth)acrylate, isooctyl (meth)acrylate, isodecyl (meth)acrylate, tridecyl (meth)acrylate, lauryl (meth)acrylate, nonyl acrylate, decyl (meth)acrylate, octyl (meth)acrylate, propyl acrylate, isobutyl acrylate, 2,2,3,3-tetrafluoropropyl acrylate, ethyl acrylate, sec-butyl acrylate, dodecyl acrylate, tetradecyl (meth)acrylate, isopropyl acrylate, pentyl (meth)acrylate, benzyl acrylate, cyclohexyl acrylate, hexadecyl (meth)acrylate, 2-methylbutyl acrylate, 2-octyl acrylate, or combinations thereof.

Clause 13. The curable composition of any preceding clause, wherein each of the chromophore monomer units may be according to formula (III):

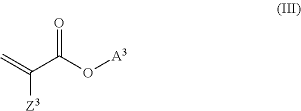

where A³ of formula (III) is X or -L-X, where L is a (C₁-C₁₀)heterohydrocarbylene linker and X is a monovalent radical of a Norrish Type II chromophore; and Z³ is —H or —CH₃.

Clause 14. The curable composition of any preceding clause, wherein each of the chromophore monomer units of the oligomer are (meth)acrylates of Nourish Type II photoinitiators.

Clause 15. The curable composition of any preceding clause, wherein the additional monomer units of the oligomer are chosen from dimethylaminoethyl acrylate, dimethylaminoethyl methacrylate, diethylaminoethyl acrylate, diethylaminoethyl methacrylate, N-vinylpyrrolidone, N-vinylcaprolactam, acryloylmorpholine, dimethyl acrylamide, a poly(ethyleneoxide) mono(meth)acrylate, hydroxyethyl ethylene urea (meth)acrylate, the reaction product of a cyclic anhydride with a hydroxy-functional (meth)acrylate, and combinations thereof.

Clause 16. The curable composition of any preceding clause, wherein the low viscosity reactive diluent comprises a monofunctional (meth)acrylate; in particular a monofunctional (meth)acrylate bearing one or more of the following groups: a ring or ring system, a C7-C20 hydrocarbon chain, one or more oxyalkylene units, one or more ester units derived from the ring-opening of a lactone (such as F-caprolactone) and combinations thereof; more particularly a monofunctional (meth)acrylate selected from isobornyl (meth)acrylate, tetrahydrofurfuryl (meth)acrylate, phenol (meth)acrylate, nonylphenol (meth)acrylate, octyl (meth)acrylate, isooctyl (meth)acrylate, 2-ethylhexyl (meth)acrylate, decyl (meth)acrylate, isodecyl (meth)acrylate; lauryl (meth)acrylate; tridecyl (meth)acrylate, stearyl (meth)acrylate, a (poly)caprolactone mono(meth)acrylate, di-, tri-, tetra- or polyethylene glycol mono(meth)acrylate, di-, tri-, tetra- or polyethylene glycol monomethyl ether (meth)acrylate, di-, tri-, tetra- or polyethylene glycol monoethyl ether (meth)acrylate, as well as the alkoxylated derivatives thereof, and combinations thereof.

Clause 17. The curable composition of any preceding clause, wherein the low viscosity reactive diluent comprises a polyfunctional (meth)acrylate; in particular a polyfunctional (meth)acrylate selected from bisphenol A di(meth)acrylate; hydrogenated bisphenol A di(meth)acrylate; ethylene glycol di(meth)acrylate; diethylene glycol di(meth)acrylate; triethylene glycol di(meth)acrylate; tetraethylene glycol di(meth)acrylate; polyethylene glycol di(meth)acrylate; propylene glycol di(meth)acrylate; dipropylene glycol di(meth)acrylate; tripropylene glycol di(meth)acrylate; tetrapropylene glycol di(meth)acrylate; polypropylene glycol di(meth)acrylate; polytetramethylene glycol di(meth)acrylate; 1,2-butanediol di(meth)acrylate; 2,3-butanediol di(meth)acrylate; 1,3-butanediol di(meth)acrylate; 1,4-butanediol di(meth)acrylate; 1,5-pentanediol di(meth)acrylate; 1,6-hexanediol di(meth)acrylate; 1,8-octanediol di(meth)acrylate; 1,9-nonanediol di(meth)acrylate; 1,10-nonanediol di(meth)acrylate; 1,12-dodecanediol di(meth)acrylate; neopentyl glycol di(meth)acrylate; 2-methyl-2,4-pentanediol di(meth)acrylate; polybutadiene di(meth)acrylate; cyclohexane-1,4-dimethanol di(meth)acrylate; tricyclodecane dimethanol di(meth)acrylate; metallic di(meth)acrylates; modified metallic di(meth)acrylates; glyceryl di(meth)acrylate; glyceryl tri(meth)acrylate; trimethylolethane tri(meth)acrylate; trimethylolethane di(meth)acrylate; trimethylolpropane tri(meth)acrylate; trimethylolpropane di(meth)acrylate; pentaerythritol di(meth)acrylate; pentaerythritol tri(meth)acrylate; pentaerythritol tetra(meth)acrylate, di(trimethylolpropane) diacrylate; di(trimethylolpropane) triacrylate; di(trimethylolpropane) tetraacrylate, sorbitol penta(meth)acrylate; di(pentaerythritol) tetraacrylate; di(pentaerythritol) pentaacrylate; di(pentaerythritol) hexa(meth)acrylate; tris (2-hydroxyethyl) isocyanurate tri(meth)acrylate; as well as the alkoxylated (e.g., ethoxylated and/or propoxylated) derivatives thereof; and combinations thereof.

Clause 18. The curable composition of any preceding clause, wherein the curable composition has a glass transition temperature T_{g} of 20° C. or less when cured or wherein the curable composition is liquid at a temperature of 25° C.±2° C.

Clause 19. The curable composition of any preceding clause, wherein the curable composition further comprises 0.1 wt % to 40 wt % of at least one tackifying resin.

Clause 20. The curable composition of any preceding clause, wherein the at least one tackifying resin has a softening temperature of 20° C. or less.

Clause 21. The curable composition of any preceding clause, wherein the at least one tackifying resin is selected from the group consisting of piperylene-based hydrocarbon resins which may be hydrogenated and hydrogenated or non-hydrogenated rosin esters, modified by maleic anhydride rosin esters.

Clause 22. The curable composition of any preceding clause, wherein the curable composition is a pressure sensitive adhesive curable composition.

Clause 23. A cured composition, wherein it is obtained by curing of the curable composition of any preceding clause.

Clause 24. The cured composition of clause 23, wherein the cured composition is a pressure sensitive adhesive in the form of an adhesive tape, an adhesive sheet, an adhesive spray, a product package, a product label, a construction article, or a medical product.

Clause 25. The cured composition of clause 23 or 24, wherein the cured composition is for packaging, labelling, construction, model making, medicine, and construction applications.

Clause 26. A pressure sensitive adhesive produced using the curable composition of any one of clauses 1 to 22.

Clause 27. A method of coating a substrate comprising: applying the curable composition of any one of clauses 1 to 22 to a substrate; and curing the curable composition by exposure to UV radiation.

Clause 28. The method of clause 27, wherein the applying step comprises applying by spraying, knife coating, roller coating, casting, drum coating, dipping or combinations thereof.

Clause 29. A method of preparing the curable composition of any one of clauses 1 to 22, wherein the method comprises the following steps:
preparing an oligomer as defined in any one of clauses 1 and 4 to 15 dissolved in a non-reactive solvent;
adding the low viscosity reactive diluent to obtain a diluted curable composition;
removing at least part of the non-reactive solvent from the diluted curable composition to obtain the curable composition according to the invention.

Clause 30. A method of curing the curable composition of any one of clauses 1 to 22 or prepared according to the method of clause 29, wherein the method comprises curing the curable composition by irradiating the curable composition with a light source having a wavelength and/or an intensity that is able to activate the polymerized chromophore monomer units of the oligomer and cause crosslinking of said oligomer and/or said reactive diluent.

It will be apparent to persons of ordinary skill in the art that various modifications and variations may be made without departing from the scope disclosed herein. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter.

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment.

1. A curable composition comprising:
an oligomer comprising, based on the total weight of the oligomer:
from 1% to 80% by weight polymerized high T_{g} monomer units, the high T_{g} monomer units being chosen from (meth)acrylate monomers having a glass transition temperature (T_{g}) greater than 25° C.;
from 10% to 98.9% by weight polymerized low T_{g} monomer units, the low T_{g} monomer units being chosen from monovalent (meth)acrylate monomers having a T_{g} equal to or less than 25° C.;
from 0.1% to 40% by weight polymerized chromophore monomer units, the chromophore monomer units being chosen from (meth)acrylate monomers having a pendent Norrish Type II chromophore; and
from 0% to 20% by weight at least one polymerized additional monomer unit; and
a low viscosity reactive diluent having a viscosity equal to or less than 3000 cP at 25° C.,
wherein:
the oligomer has a weight average molecular weight of at least 10,000 grams per mole (g/mol);
the oligomer has a T_{g} equal to or less than −10° C.; and
the curable composition has a viscosity of equal to or less than 50,000 cP at 60° C., preferably equal to or less than 50,000 cP at 25° C.

2. The curable composition of claim 1, wherein a weight ratio of the oligomer to the low viscosity reactive diluent is from 4:1 to 1:4.

3. The curable composition of claim 1, wherein the oligomer comprises, based on the total weight of the oligomer:
from 1% to 50% by weight of the polymerized high T_{g} monomer units;
from 50% to 97% by weight of the polymerized low T_{g} monomer units;
from 0.1% to 10% by weight of the polymerized chromophore monomer units; and
from 0 to 5% by weight of the polymerized additional monomer units.

4. The curable composition of claim 1, wherein the oligomer has a weight average molecular weight from 10,000 g/mol to 600,000 g/mol.

5. The curable composition of claim 1, wherein a weight ratio of low T_{g} monomer units to high T_{g} monomer units in the oligomer is from 24:1 to 1.5:1.

6. The curable composition of claim 1 wherein the T_{g} of the high T_{g} monomer units is at least 20° C. greater than the T_{g} of the low T_{g} monomer units.

7. The curable composition of claim 1, wherein the high T_{g} monomer units of the oligomer are chosen from (meth)acrylic acid, 2-phenylethyl methacrylate, 3,3,5-trimethylcyclohexyl acrylate, tert-butyl acrylate, octadecyl methacrylate, octadecyl acrylate, propyl methacrylate, benzyl methacrylate, isobutyl methacrylate, ethyl methacrylate, 2,2,3,3-tetrafluoropropyl methacrylate, 2,2,2-trifluoroethyl methacrylate, isopropyl methacrylate, isobornyl acrylate, methyl methacrylate, isobornyl methacrylate, phenyl methacrylate, tert-butyl methacrylate, cyclohexyl methacrylate, 4-tert-butylcyclohexyl acrylate, 4-tert-butylcyclohexyl methacrylate, 3,3,5-trimethylcyclohexyl acrylate, 3,3,5-trimethylcyclohexyl methacrylate, a substituted or unsubstituted (C₆-C₁₂)cycloalkyl (meth)acrylate, adamantyl (meth)acrylate, tricyclodecane methanol mono(meth)acrylate, or combinations thereof.

8. The curable composition of claim 7, wherein the high T_{g} monomer units of the oligomer are chosen from methyl methacrylate, tert-butyl (meth)acrylate, (meth)acrylic acid, isobornyl (meth)acrylate, or combinations thereof.

9. The curable composition of claim 1, wherein the low T_{g} monomer units of the oligomer are chosen from n-butyl (meth)acrylate, isobutyl acrylate, hexyl (meth)acrylate, 2-ethylhexyl (meth)acrylate, isooctyl (meth)acrylate, isodecyl (meth)acrylate, tridecyl (meth)acrylate, lauryl (meth)acrylate, nonyl acrylate, decyl (meth)acrylate, octyl (meth)acrylate, propyl acrylate, isobutyl acrylate, 2,2,3,3-tetrafluoropropyl acrylate, ethyl acrylate, sec-butyl acrylate, dodecyl acrylate, tetradecyl (meth)acrylate, isopropyl acrylate, pentyl (meth)acrylate, benzyl acrylate, cyclohexyl acrylate, hexadecyl (meth)acrylate, 2-methylbutyl acrylate, 2-octyl acrylate, or combinations thereof.

10. The curable composition of claim 1, wherein each of the chromophore monomer units of the oligomer are (meth)acrylates of Norrish Type II photoiniators.

11. The curable composition of claim 1, wherein the at least one polymerized additional monomer unit of the oligomer is chosen from dimethylaminoethyl acrylate, dimethylaminoethyl methacrylate, diethylaminoethyl acrylate, diethylaminoethyl methacrylate, N-vinylpyrrolidone, N-vinylcaprolactam, acryloylmorpholine, dimethyl acrylamide, a poly(ethyleneoxide) mono(meth)acrylate, hydroxyethyl ethylene urea (meth)acrylate, the reaction product of a cyclic anhydride with a hydroxy-functional (meth)acrylate, and combinations thereof.

12. The curable composition of claim 1, wherein the low viscosity reactive diluent comprises a monofunctional (meth)acrylate.

13. The curable composition of claim 1, wherein the low viscosity reactive diluent comprises a polyfunctional (meth)acrylate.

14. The curable composition of claim 1, wherein the curable composition has a glass transition temperature T_{g} of 20° C. or less when cured or wherein the curable composition is liquid at a temperature of 25° C.±2° C.

15. The curable composition of claim 1, wherein the curable composition is a pressure sensitive adhesive curable composition.

16. A method of preparing a curable composition comprising the following steps:
preparing an oligomer as defined in claim 1 dissolved in a non-reactive solvent;
adding a low viscosity reactive diluent to obtain a diluted curable composition; and
removing at least part of the non-reactive solvent from the diluted curable composition to obtain the curable composition.

17. A method of curing the curable composition of claim 1, wherein the method comprises curing the curable composition by irradiating the curable composition with a light source having a wavelength and/or an intensity that is able to activate the polymerized chromophore monomer units of the oligomer and cause crosslinking of said oligomer and/or said reactive diluent.

18. The curable composition of claim 12, wherein the monofunctional (meth)acrylate is selected from the group consisting of isobornyl (meth)acrylate, tetrahydrofurfuryl (meth)acrylate, phenol (meth)acrylate, nonylphenol (meth)acrylate, octyl (meth)acrylate, isooctyl (meth)acrylate, 2-ethylhexyl (meth)acrylate, decyl (meth)acrylate, isodecyl (meth)acrylate; lauryl (meth)acrylate; tridecyl (meth)acrylate, stearyl (meth)acrylate, a (poly)caprolactone mono(meth)acrylate, di-, tri-, tetra- or polyethylene glycol mono(meth)acrylate, di-, tri-, tetra- or polyethylene glycol monomethyl ether (meth)acrylate, di-, tri-, tetra- or polyethylene glycol monoethyl ether (meth)acrylate, and the alkoxylated derivatives thereof, and combinations thereof.

19. The curable composition of claim 13, wherein the polyfunctional (meth)crylate is selected from the group consisting of ethylene glycol di(meth)acrylate, di-, tri-, tetra- or polyethylene glycol di(meth)acrylate, propylene glycol di(meth)acrylate, di-, tri-, tetra- or polypropylene glycol di(meth)acrylate, 1,4-butanediol di(meth)acrylate, di-, tri-, tetra- or polybutylene glycol di(meth)acrylate, 1,6-hexanediol di(meth)acrylate, neopentyl glycol di(meth)acrylate, 1,3-butylene glycol di(meth)acrylate, tricyclodecane dimethanol di(meth)acrylate, bisphenol A di(meth)acrylate, glycerol tri(meth)acrylate, di(trimethylolpropane) tetra(meth)acrylate, dipentaerythritol penta(meth)acrylate, and the alkoxylated derivatives thereof, and combinations thereof
